(19) United States
(12) Patent Application Publication
(10) Pub. No.: US 2017/0280098 A1
(43) Pub. Date: Sep. 28, 2017

(54) TECHNIQUES FOR ENHANCING USER EXPERIENCE IN VIDEO CONFERENCING

(71) Applicant: INTEL CORPORATION, Santa Clara, CA (US)

(72) Inventors: RAMANATHAN SETHURAMAN, Bangalore, KA (IN); RAGHUNANDAN BN, Bangalore, KA (IN); RAJESH BHASKAR, Bangalore, KA (IN); JEAN-PIERRE GIACALONE, Sophia-Antipolis (FR)

(73) Assignee: INTEL CORPORATION, Santa Clara, CA (US)

(21) Appl. No.: 15/504,967

(22) PCT Filed: Sep. 26, 2014
(86) PCT No.: PCT/IB2014/002655

§ 371 Date: Feb. 17, 2017

(51) Int. Cl. H04N 7/15; H04L 12/18

(52) U.S. Cl. CPC H04N 7/15; H04L 12/1827; G01H 3/14

(57) ABSTRACT

Techniques are disclosed for enhancing user experience in video conferencing. In accordance with some embodiments, the graphical user interface (GUI) displayed on a device involved in a video conferencing session may undergo dynamic adjustment of its video composition, for example, to render video content in either a prominent or a thumbnail region of the GUI. Reorganization of the GUI's video composition may be performed, for example: (1) automatically based on detected audio activity levels of the video conferencing participants; and/or (2) upon user instruction. In accordance with some embodiments, individualized volume control over video conferencing participants may be provided. In accordance with some embodiments, the resolution and/or frame rate of video data captured at a source device involved in a video conferencing session may be adaptively varied, for example, during capture and/or processing before encoding based on the detected audio activity level of the user of that source device.

### BACKGROUND

In video conferencing, audio and visual telecommunications technologies are utilized in a collaborative manner to provide communication between users at different sites. In some types of video conferencing, a server performs synthesis of the multiparty audio-video communications event, collecting audio and video data from the individual participants, processing that data, and distributing the resultant processed data to the participant endpoint devices. In some other types of video conferencing, each participant's endpoint device itself performs synthesis of the multiparty audio-video communications event, collecting and processing participant data and rendering the resultant processed data to a given participant.

### BRIEF DESCRIPTION OF THE DRAWINGS

FIG. 1 illustrates an example computing device configured in accordance with an embodiment of the present disclosure.

FIG. 2 is a block diagram illustrating an example audio and video data flow for a computing device in a video conferencing event, in accordance with an embodiment of the present disclosure.

FIG. 3A illustrates an example screenshot of a computing device on which a graphical user interface (GUI) is displayed in a two-user dynamic prominence mode, in accordance with an embodiment of the present disclosure.

FIG. 3B illustrates an example screenshot of a computing device on which a GUI is displayed in a three-user dynamic prominence mode, in accordance with another embodiment of the present disclosure.

FIG. 3C illustrates an example screenshot of a computing device on which a GUI is displayed in an object/scene prominence mode, in accordance with another embodiment of the present disclosure.

FIG. 4A is a flow diagram illustrating an IR.94-based implementation of dynamic prominence swapping, in accordance with an embodiment of the present disclosure.

FIG. 4B is a flow diagram illustrating a WebRTC-based implementation of dynamic prominence swapping, in accordance with an embodiment of the present disclosure.

FIG. 5 illustrates an example screenshot of a computing device on which a GUI is displayed with representative video streams at differing resolution and/or frame rate, in accordance with an embodiment of the present disclosure.

FIGS. 6A-6B illustrate example screenshots of a computing device on which a GUI is displayed demonstrating user-configurable prominence swapping, in accordance with an embodiment of the present disclosure.

FIGS. 7A and 7B illustrate example screenshots of a computing device on which a GUI is displayed with individualized volume controls for video conferencing participants, in accordance with an embodiment of the present disclosure.

FIG. 8A is a flow diagram illustrating an IR.94-based implementation of individualized volume control, in accordance with an embodiment of the present disclosure.

FIG. 8B is a flow diagram illustrating a WebRTC-based implementation of individualized volume control, in accordance with an embodiment of the present disclosure.

FIG. 9 is a graph showing subjective quality (SSIM) as a function of resolution and bitrate.

FIG. 10 illustrates an example system that may carry out techniques for enhancing user experience in video conferencing as described herein, in accordance with some embodiments.

FIG. 11 illustrates embodiments of a small form factor device in which the system of FIG. 10 may be embodied.

### DETAILED DESCRIPTION

Techniques are disclosed for enhancing user experience in video conferencing. In accordance with some embodiments, the graphical user interface (GUI) displayed on a device involved in a video conferencing session may undergo dynamic adjustment of its video composition, for example, to render video content in either a prominent region or a thumbnail region of the GUI. In accordance with some embodiments, reorganization of the GUI's video composition may be performed: (1) automatically based on detected audio activity levels of the video conferencing participants; and/or (2) upon user instruction. In accordance with some embodiments, volume control over the individual audio streams of individual video conferencing participants may be provided. In accordance with some embodiments, the resolution and/or frame rate of video data captured at a source device involved in a video conferencing session may be adaptively varied, for example, during capture and/or processing before encoding based on the detected audio activity level of the user of that source device. Such adaptive adjustment may be performed, for example, in real time or otherwise as desired. Numerous variations and permutations will be apparent in light of this disclosure.

### General Overview

As the prevalence of mobile devices and social networking continues to grow, an increasing number of users seek to communicate with others via video as an alternative to typical phone calls and text-based messages. However, existing video conferencing programs face a number of limitations. For instance, video conferencing topology can be quite dynamic during a given session, but existing video conferencing programs, such as Skype and Microsoft Lync, render representative video streams of all participants only as thumbnails within the on-screen graphical user interface (GUI), regardless of which participants are speaking at a given moment during the video conferencing session. In particular, with these existing programs the video composition of the on-screen GUI does not change unless a current participant leaves the session or a new participant joins the session, and even then all participants remain rendered as thumbnails within the on-screen GUI or otherwise with fixed equal resolution and frame rate regardless of whether a given participant is active or passive in the session. As such, the GUIs associated with these existing programs have static topology and content and do not support dynamic representation of participants. In addition, existing video conferencing programs provide only limited user control options and thus are limited in the overall user experience that they can provide. For example, these existing programs do not provide GUI options for controlling the volume levels of individual video conferencing participants or for reorganizing the on-screen position of a participant's video stream during a video conferencing session. Furthermore, existing video conferencing programs are performance-intensive and consume considerable amounts of power, as well as resources such as processor bandwidth and transmission bandwidth. These limitations are further complicated with respect to mobile communication devices, which typically are limited in power supply and screen size, and thus are limited with respect to the number of users that may be presented in a given video conferencing session.

Thus, and in accordance with some embodiments of the present disclosure, techniques are disclosed for enhancing user experience in video conferencing. In accordance with some embodiments, the graphical user interface (GUI) displayed on a device involved in a video conferencing session may undergo dynamic adjustment of its video composition, for example, to render video content in either a prominent region or a thumbnail region of the GUI. In accordance with some embodiments, reorganization of the GUI's video composition may be performed: (1) automatically based on detected audio activity levels of the individual video conferencing participants; and/or (2) upon user instruction. In accordance with some embodiments, volume control over the individual audio streams of individual video conferencing participants may be provided. In accordance with some embodiments, the resolution and/or frame rate of video data captured at a source device involved in a video conferencing session may be adaptively varied, for example, during capture and/or processing before encoding based on the detected audio activity level of the user of that source device. Such adaptive adjustment may be performed, for example, in real time or otherwise as desired. Numerous configurations and variations will be apparent in light of this disclosure.

Techniques disclosed herein can be utilized, for example, in any of a wide range of forms of video-based communication (e.g., peer-to-peer video calls; multipoint video conferencing; instant messaging; voice-over-internet protocol, or VoIP, services) in any of a wide range of contexts (e.g., networking; social media) using any of a wide range of communication platforms, mobile or otherwise. It should be noted that while the disclosed techniques are generally discussed in the example context of multi-point and peer-to-peer video conferencing, they also can be used, for example, in other video-based collaborative contexts, such as virtual classrooms or any other context in which multi-point and/or peer-to-peer video-based communication can be used, in accordance with some embodiments. In some example cases, each participant involved in such a video-based collaborative context can share and/or receive (e.g., in real time) audio and/or video content provided as described herein. It should be further noted that while the disclosed techniques generally are discussed in the example context of mobile computing devices, the present disclosure is not so limited. For instance, in some cases, the disclosed techniques can be used, for example, with non-mobile computing devices (e.g., a desktop computer, a television, dedicated professional/office-based video conferencing equipment, etc.), in accordance with some embodiments. Numerous suitable host platforms will be apparent in light of this disclosure.

In some cases, use of techniques disclosed herein may realize a reduction in bandwidth consumption and/or rendering hardware usage in a video conferencing session or other video content transmission. Some embodiments may permit viewing video content of participants, for example, without having to exchange large amounts of information or otherwise consume large amounts of transmission bandwidth as is typically involved with existing video conferencing approaches. In some instances, use of techniques disclosed herein may realize an improvement in quality of service (QoS). In some cases, use of techniques disclosed herein may provide for an enhanced or otherwise enriched user experience for a given video conferencing participant. For example, in some cases, the disclosed techniques may facilitate providing a user with a rich, lifelike, face-to-face, conversational video communication/collaboration experience. In some instances, this may provide an improved video-based communication/interaction session and thus may help to increase the user's overall satisfaction and enjoyment with that experience.

System Architecture and Operation

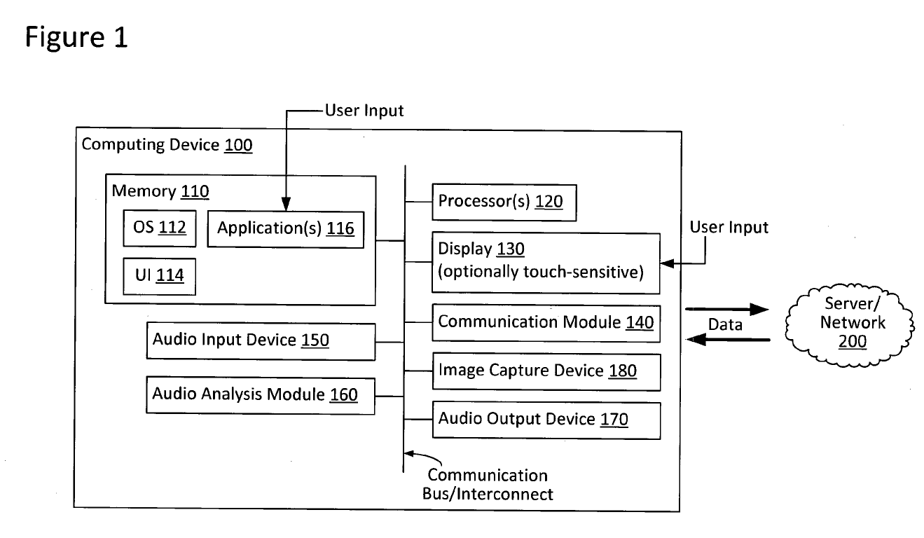

FIG. 1 illustrates an example computing device 100 configured in accordance with an embodiment of the present disclosure. Device 100 can be any of a wide range of computing platforms, mobile or otherwise. For example, in accordance with some embodiments, device 100 can be, in part or in whole: (1) a laptop/notebook computer or sub-notebook computer (e.g., Ultrabook™ device); (2) a tablet computer; (3) a mobile phone or smartphone; (4) a personal digital assistant (PDA); (5) a portable media player (PMP); (6) a cellular handset; (7) a handheld gaming device; (8) a gaming platform; (9) a desktop computer; (10) a television set; (11) a video conferencing or other video-based collaboration system; (12) a server configured to host a video conferencing session; and/or (13) a combination of any one or more thereof. Device 100 can be configured for wired (e.g., Universal Serial Bus or USB, Ethernet, FireWire, etc.) and/or wireless (e.g., Wi-Fi, Bluetooth, etc.) communication, as desired. Other suitable configurations for computing device 100 will depend on a given application and will be apparent in light of this disclosure.

As can be seen from FIG. 1, computing device 100 includes memory 110. Memory 110 can be of any suitable type (e.g., RAM and/or ROM, or other suitable memory) and size, and in some cases may be implemented with volatile memory, non-volatile memory, or a combination thereof. In some cases, memory 110 may be configured to be utilized, for example, for processor workspace (e.g., for one or more processors 120) and/or to store media, programs, applications, and/or content on computing device 100 on a temporary or permanent basis. A given processor 120 of device 100 may be configured as typically done, and in some embodiments may be configured, for example, to perform operations associated with device 100 and one or more of the modules thereof (e.g., within memory 110 or elsewhere). Numerous suitable configurations will be apparent in light of this disclosure.

As can be seen further from FIG. 1, memory 110 can include a number of modules stored therein that can be accessed and executed, for example, by the one or more processors 120 of device 100. For instance, in accordance with some embodiments, memory 110 may include an operating system (OS) 112. OS 112 can be implemented with any suitable OS, mobile or otherwise, such as, for example: (1) Android OS from Google, Inc.; (2) iOS from Apple, Inc.; (3) BlackBerry OS from BlackBerry Ltd.; (4) Windows Phone OS from Microsoft Corp; (5) Palm OS/Garnet OS from Palm, Inc.; (6) an open source OS, such as Symbian OS; and/or (7) a combination of any one or more thereof. As will be appreciated in light of this disclosure, OS 112 may be configured, for example, to aid in processing video and/or audio data during its flow through device 100. Other suitable configurations and capabilities for OS 112 will depend on a given application and will be apparent in light of this disclosure.

In accordance with some embodiments, device 100 may include a user interface (UI) module 114. In some cases, UI 114 can be implemented in memory 110 (e.g., as generally shown in FIG. 1), whereas in some other cases, UI 114 can be implemented in a combination of locations (e.g., at memory 110 and at display 130), thereby providing UI 114 with a given degree of functional distributedness. UI 114 may be configured, in accordance with some embodiments, to provide a graphical UI (GUI) that is configured, for example, to aid in carrying out any of the various video conferencing techniques discussed herein. Other suitable configurations and capabilities for UI 114 will depend on a given application and will be apparent in light of this disclosure.

In accordance with some embodiments, memory 110 may have stored therein (or otherwise have access to) one or more applications 116. In some instances, device 100 may be configured to receive user input, for example, via one or more applications 116 stored in memory 110. Other suitable modules, applications, and data which may be stored in memory 110 (or may be otherwise accessible to device 100) will depend on a given application and will be apparent in light of this disclosure.

In accordance with some embodiments, a given module of memory 110 can be implemented in any suitable standard and/or custom/proprietary programming language, such as, for example: (1) C; (2) C++; (3) objective C; (4) JavaScript; and/or (5) any other suitable custom or proprietary instruction sets, as will be apparent in light of this disclosure. The modules of memory 110 can be encoded, for example, on a machine-readable medium that, when executed by a processor 120, carries out the functionality of device 100, in part or in whole. The computer-readable medium may be, for example, a hard drive, a compact disk, a memory stick, a server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic. Some embodiments can be implemented with a microcontroller having input/output capability (e.g., inputs for receiving user inputs; outputs for directing other components) and a number of embedded routines for carrying out the device functionality. In a more general sense, the functional modules of memory 110 (e.g., OS 112; UI 114; one or more applications 116) can be implemented in hardware, software, and/or firmware, as desired for a given target application or end-use.

As can be seen further from FIG. 1, device 100 may include a display 130, in accordance with some embodiments. Display 130 can be any electronic visual display or other device configured to display or otherwise generate an image (e.g., image, video, text, and/or other displayable content) there at. In some instances, display 130 may be integrated, in part or in whole, with device 100, whereas in some other instances, display 130 may be a stand-alone component configured to communicate with device 100 using any suitable wired and/or wireless communications means. In some cases, display 130 optionally may be a touchscreen display or other touch-sensitive display. In some such cases, a touch-sensitive display 130 may facilitate user interaction with device 100 via the GUI presented by such display 130. Numerous suitable configurations for display 130 will be apparent in light of this disclosure.

Also, as can be seen from FIG. 1, device 100 may include a communication module 140, in accordance with some embodiments. Communication module 140 may be configured, for example, to allow for communication of information between device 100 and a given external source (e.g., a server/network 200; another device 100) communicatively coupled therewith. To that end, communication module 140 may be configured, in accordance with some embodiments, to utilize any of a wide range of communications protocols, such as, for example: (1) a Wi-Fi protocol; (2) a Bluetooth protocol; (3) a near field communication (NFC) protocol; (4) a local area network (LAN)-based communication protocol; (5) a cellular-based communication protocol; (6) an Internet-based communication protocol; (7) a satellite-based communication protocol; and/or (8) a combination of any one or more thereof. However, the present disclosure is not so limited to only these example communications protocols, as in a more general sense, communication module 140 may be configured to utilize any standard and/or custom/proprietary communication protocol, as desired for a given target application or end-use. Even more generally, communication module 140 may be configured, in accordance with some embodiments, to utilize any means of wired and/or wireless communication, as desired. Other suitable configurations and capabilities for communication module 140 will depend on a given application and will be apparent in light of this disclosure.

As can be seen further from FIG. 1, device 100 may include an audio input device 150, in accordance with some embodiments. Audio input device 150 can be a microphone or any other audio input device configured to sense/record sound, and may be integrated, in part or in whole, with device 100. Audio input device 150 may be implemented in any combination of hardware, software, and/or firmware, as desired for a given target application or end-use. In some instances, audio input device 150 may be configured to detect a user's voice and/or other local sounds, as desired. Other suitable configurations for audio input device 150 will depend on a given application and will be apparent in light of this disclosure.

Also, as can be seen from FIG. 1, device 100 may include an audio analysis module 160. In accordance with some embodiments, interpretation and analysis of incoming audio data (e.g., incoming from server/network 200, another device 100, audio input device 150, etc.) may be performed, in part or in whole, for example, by logic, software, and/or programming embedded within or otherwise associated with audio analysis module 160. To that end, audio analysis module 160 can be any suitable standard, custom, and/or proprietary audio analysis engine, and in some example embodiments may be a low-power audio analysis and audio signature computation engine, configured as typically done. In some instances, audio analysis module 160 may be platform-specific (e.g., may vary depending on device 100, and in some cases more particularly on the OS 112 running thereon). In some cases, audio analysis module 160 may be programmable. Numerous suitable configurations will be apparent in light of this disclosure.

In accordance with some embodiments, audio analysis module 160 may include custom, proprietary, known, and/or after-developed audio processing code (or instruction sets) that are generally well-defined and operable to receive audio input (e.g., a sensed sound from audio input device 150; audio packets of an audio data stream from a server/network 200 and/or another device 100) and to analyze or otherwise process that audio data. In some embodiments, audio analysis module 160 may be configured, for example, to compute one or more audio signatures from audio data received in a video conferencing session. In accordance with some embodiments, audio analysis module 160 may be configured, for example, to determine whether a user's detected audio activity level has passed a given audio threshold (e.g., volume level threshold and/or duration threshold, discussed below). In some cases, audio analysis module 160 may be programmable with respect to such thresholds (e.g., a given audio threshold may be user-configurable). In accordance with some embodiments, audio analysis module 160 may be configured to analyze audio data in real time or after a given period of delay, which may be a standard and/or custom value, and in some cases may be user-configurable.

In accordance with some embodiments, audio analysis module 160 may be configured to output one or more instruction signals to control a given portion of device 100. For instance, in accordance with some embodiments, if audio analysis module 160 determines, upon analysis of audio data detected/received in a video conferencing session, that a user's audio activity level has passed (e.g., risen above or fallen below) a given audio threshold of interest, then it may output an instruction signal to cause adjustment of the video composition of the GUI displayed at display 130 of device 100. Additional and/or different instructions for a given output signal of audio analysis module 160 will depend on a given application and will be apparent in light of this disclosure.

As can be seen further from FIG. 1, device 100 may include an audio output device 170, in accordance with some embodiments. Audio output device 170 can be, for example, a loudspeaker or any other device capable of producing sound from an audio data signal, such as that which may be received from audio input device 150, an upstream server/network 200, and/or another upstream device 100, in accordance with some embodiments. Audio output device 170 can be configured, in accordance with some embodiments, to reproduce sounds local to its host device 100 and/or remote sounds received, for instance, from one or more other devices 100 with which that device 100 is engaged. In some instances, audio output device 170 may be integrated, in part or in whole, with device 100, whereas in some other instances, audio output device 170 may be a stand-alone component configured to communicate with device 100 using any suitable wired and/or wireless communications means, as desired. Other suitable types and configurations for audio output device 170 will depend on a given application and will be apparent in light of this disclosure.

Also, as can be seen from FIG. 1, device 100 may include an image capture device 180, in accordance with some embodiments. Image capture device 180 can be any device configured to capture digital images, such as a still camera (e.g., a camera configured to capture still photographs) or a video camera (e.g., a camera configured to capture moving images comprising a plurality of frames). In some cases, image capture device 180 may include components such as, for instance, an optics assembly, an image sensor, and/or an image/video encoder, and may be integrated, in part or in whole, with device 100. These components (and others, if any) of image capture device 180 may be implemented in any combination of hardware, software, and/or firmware, as desired for a given target application or end-use. Image capture device 180 can be configured to operate using light, for example, in the visible spectrum and/or other portions of the electromagnetic spectrum not limited to the infrared (IR) spectrum, ultraviolet (UV) spectrum, etc. In some instances, image capture device 180 may be configured to continuously acquire imaging data. Other suitable configurations for image capture device 180 will depend on a given application and will be apparent in light of this disclosure.

Server/network 200 can be any suitable public and/or private communications network. For instance, in some cases, server/network 200 may be a private local area network (LAN) operatively coupled to a wide area network (WAN), such as the Internet. In some cases, server/network 200 may include one or more second-generation (2G), third-generation (3G), and/or fourth-generation (4G) mobile communication technologies. In some cases, server/network 200 may include a wireless local area network (WLAN) (e.g., Wi-Fi wireless data communication technologies). In some instances, server/network 200 may include Bluetooth wireless data communication technologies. In some cases, server/network 200 may include supporting infrastructure and/or functionalities, such as a server and a service provider, but such features are not necessary to carry out communication via server/network 200. Numerous configurations for server/network 200 will be apparent in light of this disclosure.

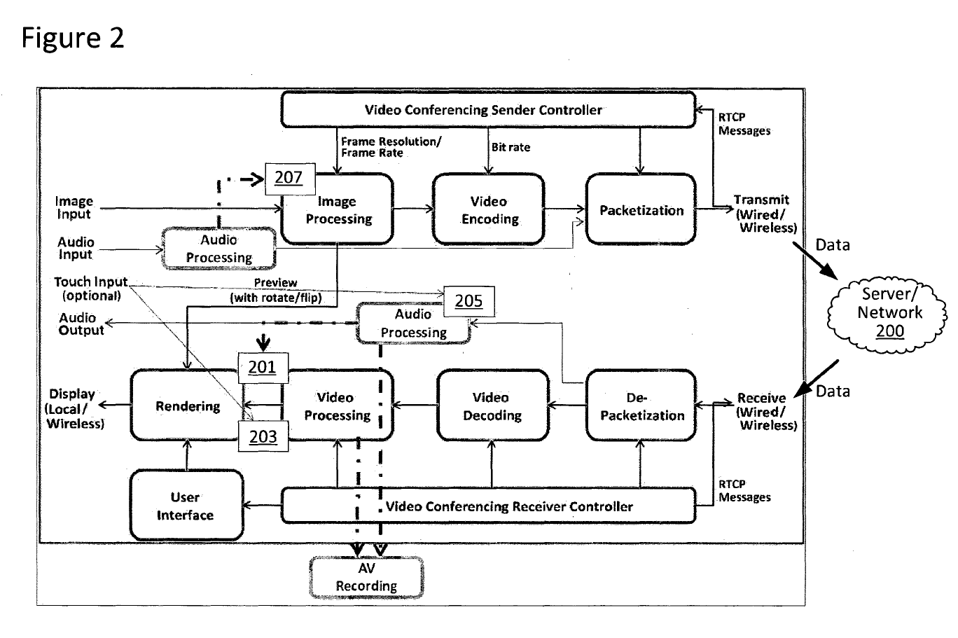

FIG. 2 is a block diagram illustrating an example audio and video data flow for a computing device 100 in a video conferencing event, in accordance with an embodiment of the present disclosure. As discussed herein, techniques associated with providing a given dynamic prominence feature/mode (as described herein) may be implemented, in part or in whole, for example, at point 201 of FIG. 2. Also, techniques associated with providing user-configurable prominence swapping (as described herein) may be implemented, in part or in whole, for example, at point 203 of FIG. 2. Furthermore, techniques associated with providing individualized volume control (as described herein) may be implemented, in part or in whole, for example, at point 205 of FIG. 2. Still further, techniques associated with providing adaptive video encoding (as described herein) may be implemented, in part or in whole, for example, at point 207 of FIG. 2. As will be appreciated in light of this disclosure, the audio and video data flow of FIG. 2 may be applicable, for example, in IR.94-based and/or WebRTC-based implementations of techniques disclosed herein, in accordance with some embodiments.

Dynamic Prominence Swapping and User-Configurable Prominence Swapping

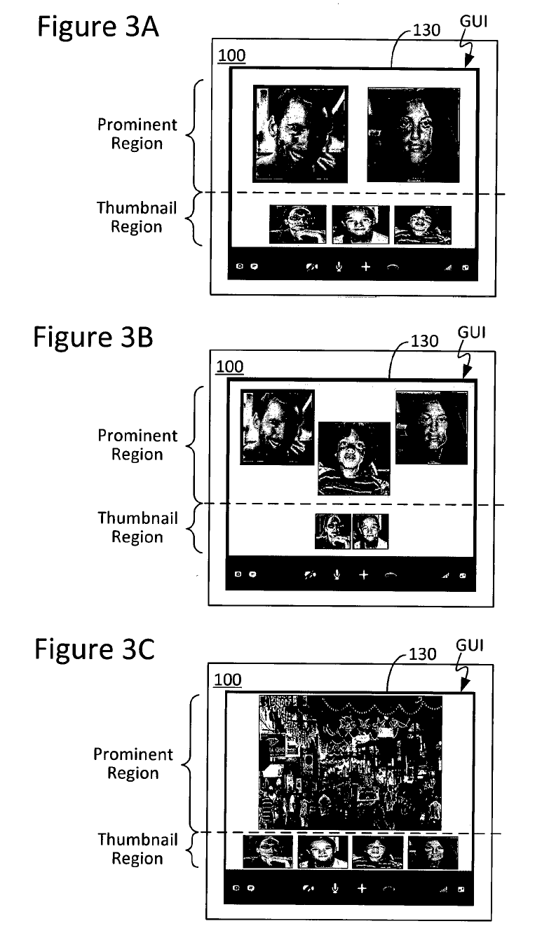

In accordance with some embodiments, the video composition of the on-screen GUI presented at a given endpoint device 100 involved in a video conferencing session may undergo dynamic adjustment, for example, to reflect changes to the dynamic topology of that video conferencing event. In some cases, provision of dynamic adjustment of the video composition of a video conferencing GUI may provide a more realistic communications context at any given point in time by rendering the GUI such that participant(s) actively involved in the video conferencing session are featured with on-screen prominence, whereas other inactive or insufficiently active participant(s) remain featured as thumbnails with comparatively lesser prominence. For example, consider FIG. 3A, which illustrates an example screenshot of a computing device 100 on which a GUI is displayed in a two-user dynamic prominence mode, in accordance with an embodiment of the present disclosure. Here, the video composition of the GUI is rendered on the device 100 such that the video streams associated with two sufficiently active participants are rendered with prominence (e.g., with larger representative images) within a Prominent Region of the GUI, whereas the video streams associated with any remaining participants are rendered with a comparatively lesser standing (e.g., with thumbnail or otherwise reduced-size representative images) within a Thumbnail Region of the GUI, in accordance with some embodiments.

Also, consider FIG. 3B, which illustrates an example screenshot of a computing device 100 on which a GUI is displayed in a three-user dynamic prominence mode, in accordance with another embodiment of the present disclosure. Here, the video composition of the GUI is rendered on the device 100 such that the video streams associated with three sufficiently active participants are rendered with prominence (e.g., with larger representative images) within a Prominent Region of the GUI, whereas the video streams associated with any remaining participants are rendered with a comparatively lesser standing (e.g., with thumbnail or otherwise reduced-size representative images) within a Thumbnail Region of the GUI, in accordance with some embodiments. It should be noted, however, that the present disclosure is not so limited only to two user-prominent or three user-prominent GUI video rendering modes, as in a more general sense, and in accordance with some other embodiments, lesser and/or greater quantities of prominently featured participants (e.g., one, four, five, six, or more prominent participants) may be provided with dynamic prominence in an on-screen GUI, as described herein, as desired for a given target application or end-use.

It should be further noted that the present disclosure is not so limited only to user-centric dynamic prominence modes. For example, consider FIG. 3C, which illustrates an example screenshot of a computing device 100 on which a GUI is displayed in an object/scene prominence mode, in accordance with another embodiment of the present disclosure. Here, the video composition of the GUI is rendered on the device 100 such that a video stream associated with a single object or scene of interest is rendered with prominence (e.g., with larger representative image) within a Prominent Region of the GUI, whereas the video streams associated with any participants are rendered with a comparatively lesser standing (e.g., with thumbnail or otherwise reduced-size representative images) within a Thumbnail Region of the GUI, in accordance with some embodiments. As will be appreciated in light of this disclosure, the video stream associated with the object/scene of interest may be provided by any of a wide range of sources, including, for example, an image capture device 180 facing a given target of interest (e.g., which may be user-selected), video content which a given participant wishes to share with other participants, or any other video data source, as desired. In some instances, the video stream associated with the object/scene of interest may be utilized in a screen sharing scenario, for example, where multiple participants are in frame at a given moment in the video conferencing session. Numerous configurations will be apparent in light of this disclosure.

For a given dynamic prominence mode (e.g., two-user; three-user; object/scene; etc.), dynamic adjustment of the video composition of the on-screen GUI may be performed, for example, based on detection and analysis of the audio activity levels of the participants of the video conferencing session, in accordance with some embodiments. To that end, the audio stream coming from each participant may undergo analysis to determine each participant's detected audio activity level. More particularly, based on the detected and analyzed audio activity of a given participant, the video composition of the GUI at a given device 100 can be adjusted (e.g., automatically) such that, at a given moment during the video conferencing session, the video stream associated with that participant may be rendered on-screen, in accordance with some embodiments, at either: (1) a Prominent Region of the GUI; or (2) a Thumbnail Region of the GUI.

If the detected audio activity level of a given participant is sufficiently high (e.g., above a given audio threshold, such as a volume level threshold and/or a duration threshold, discussed below), then the video stream associated with that participant may be rendered within a Prominent Region of the on-screen GUI, in accordance with some embodiments. If instead the detected audio activity level of a given participant is not sufficiently high (e.g., below a given audio threshold), then the video stream associated with that participant may be rendered within a Thumbnail Region of the on-screen GUI, in accordance with some embodiments. To provide for dynamic changes in the topology of the video conferencing session which reflect changes in participant activity levels (e.g., when a given participant has increased or decreased his/her activity level), the video composition of the GUI at a given device 100 may undergo dynamic adjustment, for example, to cause the video stream associated with that participant to be either promoted from the Thumbnail Region to the Prominent Region or demoted from the Prominent Region to the Thumbnail Region, in accordance with some embodiments. More particularly, if the audio activity level of a given participant has sufficiently increased so as to warrant comparative prominence within the on-screen GUI, then the video stream representative of that participant may be transitioned automatically, for example, from the Thumbnail Region to the Prominent Region to signify such increase in activity level, in accordance with some embodiments. Conversely, if the audio activity level of a participant has sufficiently decreased so as to no longer warrant comparative prominence within the on-screen GUI, then the video stream representative of that participant may be transitioned automatically, for example, from the Prominent Region to the Thumbnail Region to signify such decrease in activity level, in accordance with some embodiments.

To determine whether a given state of prominence is warranted within the context of a video conferencing session, a given participant's detected audio activity level may be compared against one or more audio thresholds, such as, for example, a volume level threshold and/or a duration threshold, in accordance with some embodiments. Determination of whether the detected audio activity level of a given participant has passed a given audio threshold of interest may be obtained, for example, via audio sampling (e.g., utilizing audio analysis module 160) of the audio data stream coming from that participant's device 100, in accordance with some embodiments. More particularly, if the detected audio activity level of a given participant exceeds or falls below a given audio threshold (e.g., volume level threshold; duration threshold), then the prominence of that participant's representative video stream within the on-screen GUI may be transitioned accordingly to the Prominent Region or Thumbnail Region from its current location, in accordance with some embodiments. For instance, if the detected audio activity level of a given participant sufficiently increases in volume level and/or duration so as to exceed an audio threshold of interest, then the video stream representative of that participant may be automatically promoted (or otherwise transitioned) from the Thumbnail Region to the Prominent Region, in accordance with an embodiment. If the detected audio activity level of a given participant remains sufficiently high in volume level and/or duration (e.g., above threshold), then the video stream representative of that participant may remain within the Prominent Region, in accordance with an embodiment. If instead the detected audio activity level of a given participant sufficiently decreases in volume level and/or duration so as to fall below an audio threshold of interest, then the video stream representative of that participant may be automatically demoted (or otherwise transitioned) from the Prominent Region to the Thumbnail Region, in accordance with an embodiment. If the detected audio activity level of a given participant remains sufficiently low in volume level and/or duration (e.g., below threshold), then the video stream representative of that participant may remain within the Thumbnail Region, in accordance with an embodiment.

In some cases, if a participant's representative video stream is promoted from a Thumbnail Region of the GUI to a Prominent Region of the GUI, a corresponding demotion of another participant's representative video stream from the Prominent Region of the GUI to the Thumbnail Region of the GUI may be provided, in accordance with some embodiments. For instance, this may occur in some cases in which the maximum number of prominent participants is reached (e.g., two, three, or more prominent participants, as desired). By way of an example, consider the case of a three-user prominence limit. If at a given moment during the video conferencing session there are currently two participants featured with on-screen prominence, and a third participant qualifies for on-screen prominence, then the video composition of the on-screen GUI may transition from prominently featuring two participants to prominently featuring three participants, in accordance with an example embodiment. However, if at a given moment during the video conferencing session there are currently three participants featured with on-screen prominence, and a fourth participant qualifies for on-screen prominence, then the video composition of the on-screen GUI may transition by swapping out one of the currently prominent participants (e.g., the participant having the lowest audio activity level of the four participants qualifying for on-screen prominence) with the fourth participant now qualifying for on-screen prominence, in accordance with an example embodiment. Otherwise put, an existing prominently featured participant may be demoted in prominence to allow for the newly qualifying participant to be promoted in prominence, in accordance with an example embodiment.

A given audio threshold (e.g., volume level threshold; duration threshold; etc.) can be set at any standard and/or custom value, and in some cases may be user-configurable. In some instances, it may be desirable to ensure that a given audio threshold is of sufficient value (e.g., a sufficiently high intensity level for a volume level threshold; a sufficiently protracted period of time for a duration threshold), for example, to minimize or otherwise reduce unwanted triggering of a prominence transition within the on-screen GUI by ambient noise detected by the audio input device 150 of a given participant's device 100. In some cases, a given audio threshold may be selected, at least in part, based on the location of the user (e.g., in an office; in an airport; at home; at a concert; etc.). In some cases, a given audio threshold may be selected, at least in part, based on the nature/context of the video conferencing session itself (e.g., social networking; business presentation; etc.). In accordance with some embodiments, a given audio threshold can be adjusted to provide for greater and/or lesser sensitivity of dynamic prominence transitions, as described herein, to environmental and/or contextual factors, as desired for a given target application or end-use. In some cases, it may be desirable to ensure that all (or some sub-set) of the audio thresholds are of sufficient value such that a prominence transition of a participant's representative video stream from one region to another within the GUI is smooth, to a greater or lesser degree, and not so excessive or so moderate in frequency as to result in a confusing or otherwise disruptive video communication experience for the user. In some instances, a given threshold may be set, for example, so as to eliminate or otherwise reduce transitions at periods of pause/silence in conversation amongst participants in the video conferencing session. Also, it should be noted that a prominence transition can be performed in real time or after a given period of delay, which may be a standard and/or custom value, and in some cases may be user-configurable, in accordance with some embodiments.

In accordance with some embodiments, at any given moment during a video conferencing session, a given participant may be categorized into any of several so-called audio activity states, for example, based on analysis of the audio stream coming from that participant. More particularly, in accordance with some embodiments, a given participant may be classified as: (1) an idle participant having no or otherwise minimal audio activity (hereinafter, Audio Activity State A0); (2) an active participant having some audio activity which does not exceed a given audio threshold of interest (hereinafter, Audio Activity State A1); and/or (3) an active participant having audio activity which exceeds a given audio threshold of interest (hereinafter, Audio Activity State A2). In accordance with some embodiments, determination of whether a given participant's detected audio activity level exceeds a given audio threshold of interest (e.g., volume level threshold; duration threshold) for purposes of classification under a given Audio Activity State A0 through A2 may be made, for example, via audio analysis module 160 based on audio input sensed/received by device 100.

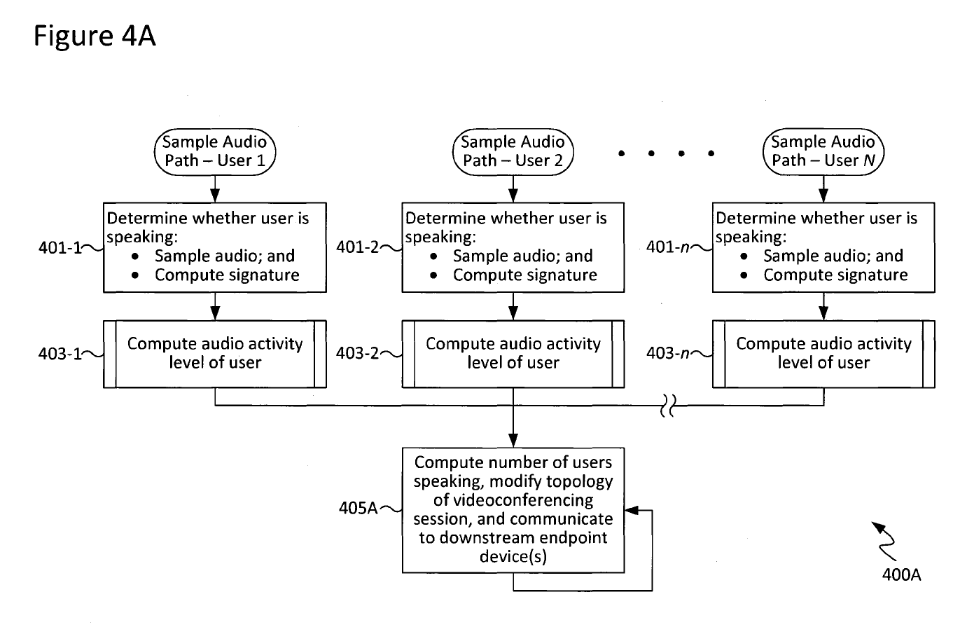

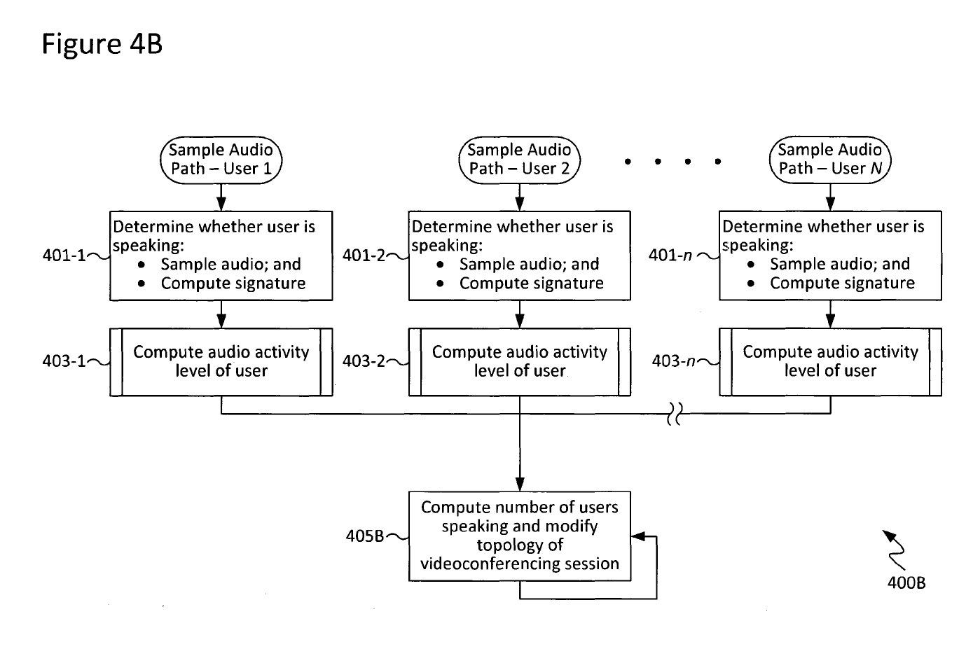

In accordance with some embodiments, a given dynamic prominence mode can be provided, for example, by a service-provider server/network 200 via an IR.94-based implementation or other suitable centralized server-based video conferencing service offered by a network service provider. FIG. 4A is a flow diagram illustrating an IR.94-based implementation of dynamic prominence swapping, in accordance with an embodiment of the present disclosure. The flow 400A of FIG. 4A may be performed, in part or in whole, at a server/network 200, in accordance with some embodiments. As can be seen, the flow 400A may begin as in blocks 401-1 through 401-n (where N users are party to a video conferencing session) with determining which participant is associated with which video stream coming from each device 100 involved in the video conferencing session. To that end, the audio stream(s) coming from the source device(s) 100 may undergo audio sampling and audio signature computation for each participant. Audio signature computation may be performed by audio analysis module 160 and may occur at periodic intervals, user-configurable intervals, or otherwise as frequently as desired for a given target application or end-use. In some cases, audio signature computation may be performed, for example, utilizing frequency transforms correlated with audio samples taken from the incoming audio stream(s).

The flow 400A may continue as in blocks 403-1 through 403-n with computing the audio activity level of each participant. Here, at each sample time, the audio activity level of a given participant may be checked against a given threshold of interest (e.g., volume level threshold; duration threshold; etc.) to determine whether that threshold is passed or not. In accordance with some embodiments, the volume level of the audio input provided by a given participant may be compared against a given volume level threshold to make a determination of that participant's audio activity level. In accordance with some embodiments, the duration of the audio input provided by a given participant may be compared against a given duration threshold to make a determination of that participant's audio activity level. In a more general sense, the audio input provided by a given participant may be checked against any one or more audio thresholds of interest in determining that participant's audio activity level, as desired for a given target application or end-use. Based on the results of this analysis, a given participant may be classified, for example, as active, inactive, or transitioning there between. In accordance with some embodiments, the results of this analysis may be utilized, for example, for purposes of classification of a given participant under a given Audio Activity State A0, A1, or A2 (discussed above).

Thereafter, the flow 400A may continue as in block 405A with computing the number of active participants in the video conferencing session at the sampling time, dynamically adjusting the topology of the session accordingly, and communicating that information to the downstream endpoint device(s) 100 participating in the session so that the on-screen GUI presented at those downstream device(s) 100 can be rendered with a video composition that reflects the dynamic changes to the session topology (e.g., by promoting and/or demoting participants between the Prominent Region and Thumbnail Region of the GUI presented at a given endpoint device 100).

It should be noted, however, that the present disclosure is not so limited only to network server-based implementations of a given dynamic prominence mode. In accordance with some other embodiments, a given dynamic prominence mode can be provided, for example, by a given endpoint device 100 via a WebRTC-based implementation or other suitable decentralized video conferencing service in which each endpoint device 100 manages multi-party rendering individually. FIG. 4B is a flow diagram illustrating a WebRTC-based implementation of dynamic prominence swapping, in accordance with an embodiment of the present disclosure. The flow 400B of FIG. 4B may be performed, in part or in whole, at a given endpoint device 100, in accordance with some embodiments. As can be seen here, the flow 400B may begin as in blocks 401-1 through 401-n (where N users are party to a given video conferencing session) and continue as in blocks 403-1 through 403-n, as described above, for instance, with respect to FIG. 4A. Thereafter, the flow 400B may continue as in block 405B with computing the number of active participants in the video conferencing session at the sampling time and dynamically adjusting the topology of the session accordingly so that the on-screen GUI presented at those device(s) 100 can be rendered with a video composition that reflects the dynamic changes to the session topology (e.g., by promoting and/or demoting participants between the Prominent Region and Thumbnail Region of the GUI presented at a given endpoint device 100).

A given video conferencing session may be started as either IR.94-based or WebRTC-based, and the appropriate flow (e.g., FIG. 4A or FIG. 4B) for a given dynamic prominence mode may be enforced accordingly, in accordance with some embodiments. In some instances, selection of a given implementation may be based, at least in part, on the number of participants in the video conferencing session, in accordance with some embodiments.

Numerous variations on the methodologies of FIGS. 4A and 4B will be apparent in light of this disclosure. As will be appreciated, and in accordance with some embodiments, each of the functional boxes (e.g., 401-1 through 401-n; 403-1 through 403-n; 405A; 405B) shown in FIGS. 4A and 4B can be implemented, for example, as a module or sub-module that, when executed by one or more processors 120 or otherwise operated, causes the associated functionality as described herein to be carried out. The modules/sub-modules may be implemented, for instance, in software (e.g., executable instructions stored on one or more computer readable media), firmware (e.g., embedded routines of a microcontroller or other device which may have I/O capacity for soliciting input from a user and providing responses to user requests), and/or hardware (e.g., gate level logic, field-programmable gate array, purpose-built silicon, etc.).

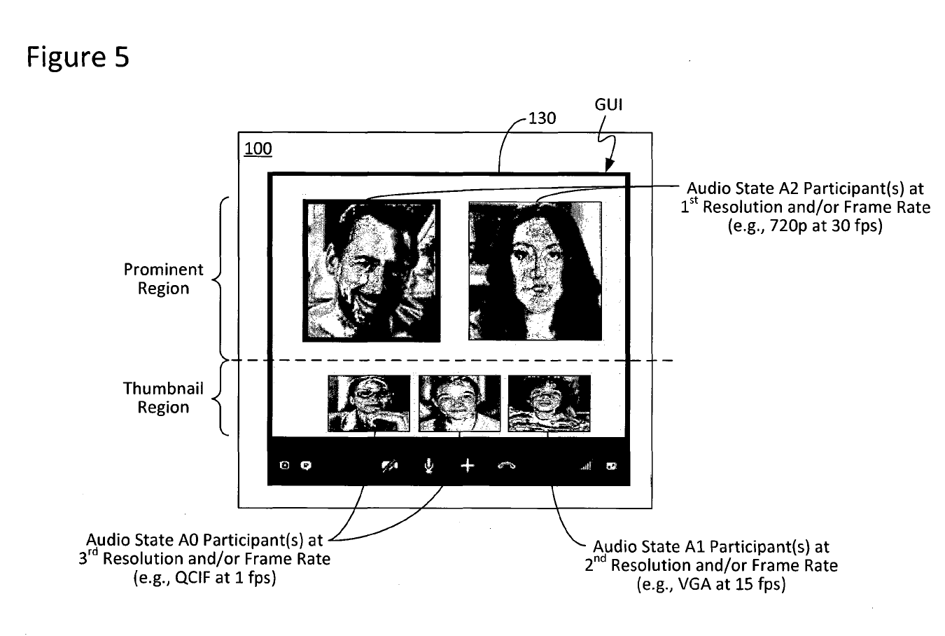

With an IR.94-based implementation of a given dynamic prominence mode, there is opportunity for individual video streams to be presented in the on-screen GUI of a given local device 100 with fixed or variable resolution and/or frame rate based on the output of upstream server/network 200. For instance, consider FIG. 5, which illustrates an example screenshot of a computing device 100 on which a GUI is displayed with representative video streams at differing resolution and/or frame rate, in accordance with an embodiment of the present disclosure. As can be seen here, a video stream associated with a participant that is classified in Audio Activity State A2 (e.g., having a detected audio activity level which exceeds a given audio threshold of interest) and is thus featured within the Prominent Region of the on-screen GUI may be presented at a first resolution and/or frame rate (e.g., 720p at 30 fps), in accordance with some embodiments. A video stream associated with a participant that is classified in Audio Activity State A1 (e.g., having a detected audio activity level which does not cross a given audio threshold of interest) and is thus featured within the Thumbnail Region of the on-screen GUI may be presented at a second, different resolution and/or frame rate (e.g., VGA at 15 fps), in accordance with some embodiments. A video stream associated with a participant that is classified in Audio Activity State A0 (e.g., having no or otherwise minimal audio activity) and is thus featured within the Thumbnail Region of the on-screen GUI may be presented at a third, different resolution and/or frame rate (e.g., QCIF at 1 fps), in accordance with some embodiments. It should be noted, however, that the present disclosure is not so limited to only these example resolutions and frame rates, as in a more general sense, and in accordance with some other embodiments, the resolution and frame rate of the video stream associated with a given video conferencing session participant, whether featured in a Prominent Region or a Thumbnail Region of the GUI, can be customized as desired for a given target application or end-use. In some cases, the individual video streams received from the source devices 100 may be adjusted by server/network 200, for example, to optimize (or otherwise customize) bandwidth usage before being delivered to a given downstream endpoint device 100, in accordance with an embodiment.

In accordance with some embodiments, for IR.94-based implementations of a given dynamic prominence mode, server/network 200 may compose a GUI frame depending on the audio activity level of each participant, giving prominence to video stream(s) associated with participant(s) having a sufficiently high audio activity level (e.g., classified as Audio Activity State A2), while giving lesser thumbnail prominence to video stream(s) associated with participant(s) not having a sufficiently high audio activity level (e.g., classified as Audio Activity State A0 and A1). The resultant composed frame, including regions of varying refresh rate, can undergo re-encoding by server/network 200, and the resultant single bit stream may be sent to one or more downstream endpoint devices 100, in accordance with some embodiments. In some instances, the re-encoding process may benefit from the fact that portion(s) of the frame relating to thumbnails (e.g., within the Thumbnail Region) refresh at a comparatively lower frame rate (e.g., 15 fps or 1 fps), and portion(s) of the frame relating to prominent images (e.g., within the Prominent Region) refresh at a comparatively higher frame rate (e.g., 30 fps), thereby allowing the encoder of server/network 200 to allocate more bits for those portions that change more frequently (e.g., change each frame) as compared to portions that change less frequently, in accordance with some embodiments. If the N input bit streams received by server/network 200 from N source devices 100 are of uniform resolution and/or frame rate, then server/network 200 may downscale spatially (resolution) and/or temporally (frame rate) before composition of the GUI frame and subsequent re-encoding thereof, in accordance with some embodiments.

With a WebRTC-based implementation of a given dynamic prominence mode, a given endpoint device 100 may compose a GUI frame depending on the audio activity level of each participant, giving prominence to video stream(s) associated with participant(s) having a sufficiently high audio activity level (e.g., classified as Audio Activity State A2), while giving lesser thumbnail prominence to video stream(s) associated with participant(s) not having a sufficiently high audio activity level (e.g., classified as Audio Activity State A0 and A1). In accordance with some embodiments, all (or some sub-set) of the participants' bit streams (N−1) that arrive at a local endpoint device 100 may be combined (composed) into a single displayable GUI frame that also takes into account the video associated with the local participant (e.g., captured by image capture device 180 of that local endpoint device 100). If the (N−1) downlink inputs from remote devices 100 and one input from local device 100 are of the same resolution, then local endpoint device 100 may downscale spatially (resolution), for example, to reflect their prominence based on the detected audio activity levels of the participants before composition of the GUI frame and sending thereof to the display 130 of the local device 100, in accordance with some embodiments. In some instances, a user-configurable representation may be used to fit in the incoming video stream(s) that arrive at the endpoint device 100 for rendering based on dynamic audio recognition analysis for partitioning video stream(s) representative of participants into a Prominent Region and a Thumbnail Region within the on-screen GUI, in accordance with some embodiments.

In some instances, it may be desirable to provide a given user with the ability to actively control the video composition of the GUI presented at a given endpoint device 100, for example, by reorganizing (e.g., swapping) video stream content for display within the on-screen GUI. To that end, with user-configurable prominence swapping, as described herein, a user may have the option to force a given endpoint device 100 to render the incoming video stream within a Prominent Region and/or a Thumbnail Region of the on-screen GUI presented at that device 100, in accordance with some embodiments. In a more general sense, a user may be provided with the option to change the on-screen presentation of an incoming video stream from the upstream server/network 200 or an upstream source device 100 with participant(s) of his/her own interest. For instance, in an example case, a user may actively swap out his/her representative video stream from a default position in the Prominent Region with the representative video stream of a given participant of interest in the Thumbnail Region. In another example case, a user may actively demote the representative video stream of an overly active participant from the Prominent Region to the Thumbnail Region. Numerous example user-configurable prominence swapping scenarios will be apparent in light of this disclosure.

User-configurable prominence swapping can be provided, in accordance with some embodiments, via an IR.94-based implementation. In such cases, a single master user/controller (or some other limited quantity of master users/controllers) may be provided with the ability to initiate prominence swapping via a request to server/network 200 for all (or some sub-set) of the downstream devices 100 involved in a video conferencing session. In some such instances, user-configurable reorganization of the GUI video composition may be performed, for example, at service provider server/network 200 with no (or otherwise minimal) control or support from a given downstream endpoint device 100. Server/network 200 may send out the resultant bit stream to all (or some sub-set) of the downstream devices 100 involved in the video conferencing session. In an example case, such user-configurable prominence swapping may be utilized, for instance, where a host entity (e.g., a television channel) is conducting the video conferencing session and wants to be the sole controller/server of prominence management and video stream swapping.

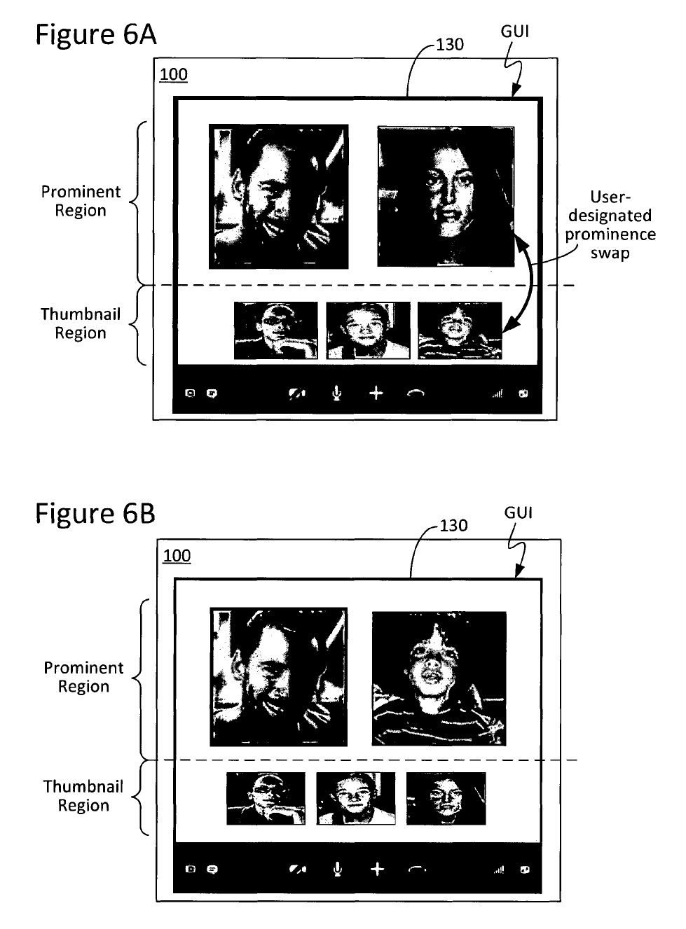

However, the present disclosure is not so limited, as in accordance with some other embodiments, user-configurable prominence swapping can be provided, for example, via a WebRTC-based implementation. In such cases, a given user may be provided with the ability to initiate prominence swapping locally at his/her endpoint device 100 without affecting other users at remote endpoint devices 100 involved in the videoconferencing session. For example, consider FIGS. 6A-6B, which illustrate example screenshots of a computing device 100 on which a GUI is displayed demonstrating user-configurable prominence swapping, in accordance with an embodiment of the present disclosure. As can be seen here, a user may provide input to device 100, for example, via the on-screen GUI presented on display 130 (and/or via an application 116) to reorganize the on-screen prominence of the video stream of a given participant, in accordance with some embodiments. User input may be, for example, touch-based (e.g., activation of a physical/virtual button), gesture-based, voice-based, and/or context/activity-based, among others. In this manner, a user may actively swap video content between the Prominent Region and the Thumbnail Region of the GUI, thereby controlling the video stream that he/she would like to view at endpoint device 100.

In some WebRTC-based implementations, user-configurable reorganization of the GUI video composition may be performed, for example, at an endpoint device 100 with no (or otherwise minimal) control or support from an upstream server/network 200. To that end, user-configurable prominence swapping may be provided at a user's endpoint device 100, in accordance with some embodiments, by: (1) locating the Prominent Region and the Thumbnail Region of the GUI presented on the display 130 of the endpoint device 100; (2) breaking the incoming video stream into these two regions; and (3) recomposing the video stream based on the user's selected video composition ordering/topology. In accordance with some embodiments, synthesis of the video stream may be performed, in part or in whole, at the server/network 200 and/or at a given endpoint device 100, as desired for a given target application or end-use. As will be appreciated in light of this disclosure, processing involved with user-configurable prominence swapping may be substantially similar to that discussed above, for instance, with respect to dynamic prominence swapping, in accordance with some embodiments.

A given video conferencing session may be started as either IR.94-based or WebRTC-based, and the appropriate flow for a given user-configurable prominence mode may be enforced accordingly, in accordance with some embodiments. As will be appreciated in light of this disclosure, in an IR.94-based session, a given user may have the ability to make a request for prominence swapping which impacts other users in the video conferencing session, in accordance with an embodiment. As will be further appreciated, in a WebRTC-based session, a given user's request for prominence swapping may not impact other users in the video conferencing session, in accordance with an embodiment. In a more general sense, the level of user control for prominence swapping within a given video conferencing session may depend, at least in part, on whether the session is IR.94-based or WebRTC-based, in some embodiments.

As will be appreciated in light of this disclosure, in some cases, user-configurable prominence swapping may support upscaling/downscaling, frame rate conversion, and/or other video enhancement options, for instance, to enrich the video representation opted by the user. In some IR.94-based implementations in which a master user/controller requests a user-configurable prominence swap, such swapping (e.g., from the Thumbnail Region to the Prominent Region) may be made, for example, by scaling from VGA resolution to 720p resolution. Here, the server/network 200 may receive video input from the endpoint device 100 at a given intermediate resolution (e.g., VGA for Audio Activity State A1) and then apply scaling to a comparatively higher resolution (e.g., 720p) when the master user/controller requests a user-configurable prominence swap. In turn, the resultant re-encoded bit stream may be delivered downstream to participants in the video conferencing session. These actions may be effected, for example, at server/network 200, in accordance with some embodiments. In some cases, the impact on scaling quality may not be (or else may be only minimally) perceived visually, in that this relatively small jump in resolution may minimize the presence of visual artifacts, reducing any impact thereof on the video stream viewable via the on-screen GUI presented at endpoint device 100.

In some other IR.94-based implementations in which a non-master user/controller requests a user-configurable prominence swap to be executed on the local endpoint device 100, such swapping (e.g., from the Thumbnail Region to the Prominent Region) may be made, for example, by scaling from QCIF resolution to 720p resolution. These actions may be effected, for example, at endpoint device 100 without being known to the upstream server/network 200 or other participant endpoint devices 100, in accordance with some embodiments. In some cases, the impact on scaling quality may be perceived visually, in that this relatively large jump in resolution may produce visual artifacts that can negatively impact the video stream viewable via the on-screen GUI presented at endpoint device 100.

In some WebRTC-based implementations in which a user requests a user-configurable prominence swap, such swapping (e.g., from the Thumbnail Region to the Prominent Region) may be made, for example, by scaling from VGA resolution to 720p resolution. These actions may be effected, for example, at the endpoint device 100 without being known to the upstream server/network 200 or other participant endpoint devices 100, in accordance with some embodiments. In some cases, there may be no (or otherwise negligible) impact on scaling quality (e.g., which cannot be perceived visually), avoiding or otherwise minimizing visual artifacts in the video stream viewable via the on-screen GUI presented at endpoint device 100.

In accordance with some embodiments, operations associated with dynamic prominence swapping or user-configurable prominence swapping (as described herein) can be implemented, for example, at the hardware level (e.g., system-on-chip, or SOC, design) and/or at the service provider level, as desired for a given target application or end-use. In some cases, operations associated with a given dynamic prominence mode or user-configurable prominence swapping may involve only destination-side processing (e.g., at a given endpoint device 100) and may not involve any (or otherwise may involve only minimal) source-side processing (e.g., at a service provider server/network 200 and/or at a given source device 100). In accordance with some embodiments, synthesis of the audio and/or video stream(s) coming from source device(s) 100 participating in a given video conferencing session may be performed, in part or in whole, at server/network 200 and/or at a given endpoint device 100 (e.g., utilizing native hardware accelerators of SOC). In accordance with an example embodiment, operations associated with a given dynamic prominence mode may be implemented, for example, at point 201 of the flow of FIG. 2. In accordance with some embodiments, operations associated with user-configurable prominence swapping may be implemented, for example, at point 203 of the flow of FIG. 2. In some cases, provision of an audio-based triggering of on-screen prominence may enhance the user experience in a more natural way, for example, than static content provided by existing video conferencing programs. In some instances, a given dynamic prominence mode may enable large multi-party (e.g., ten or more people) video conferencing through dynamic/smart activity detection to distinguish between presenter/active participant and listeners/audience. In some cases, the use of dynamic speaker selection into regions of topology may help to increase the maximum user limit in an endpoint device 100 having a display 130 of limited size (e.g., such as a smartphone, tablet, or other mobile computing device). Other suitable implementations of a given dynamic prominence mode and user-configurable prominence swapping, as described herein, will depend on a given application and will be apparent in light of this disclosure.

Individualized Volume Control

In some instances, it may be desirable to provide a local user with the ability to adjust audio volume levels of individual remote participants in a video conferencing session. To that end, the on-screen GUI presented at a given endpoint device 100 may be configured, in accordance with some embodiments, to allow a user to control (e.g., increase, decrease, and/or mute) the volume of the audio stream associated with a given individual participant in a video conferencing session.

In accordance with some embodiments, individualized volume control can be provided, for example, via an IR.94-based implementation. In such cases, a single master user/controller (or some other limited quantity of master users/controllers) may be provided with the ability to control volume levels via a request to server/network 200 for all (or some sub-set) of the downstream devices 100 involved in a video conferencing session. In some such instances, individualized volume control may be performed, for example, at service provider server/network 200 with no (or otherwise minimal) control or support from a given downstream endpoint device 100. Server/network 200 may send out the resultant bit stream to all (or some sub-set) of the downstream devices 100 involved in the video conferencing session. In an example case, such individualized volume control may be utilized, for instance, where a host entity (e.g., a television channel) is conducting the video conferencing session and wants to be the sole controller/server of audio levels to participants.

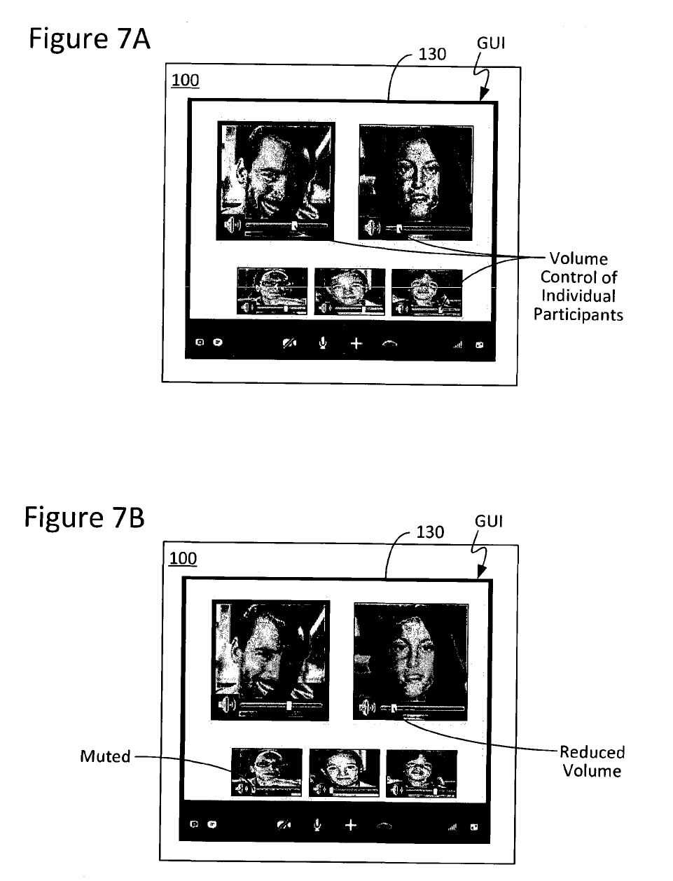

However, the present disclosure is not so limited, as in accordance with some other embodiments, individualized volume control can be provided, for example, via a WebRTC-based implementation. In such cases, a given user may be provided with the ability to control audio levels locally at his/her endpoint device 100 without affecting other users at remote endpoint devices 100 involved in the videoconferencing session. For example, consider FIGS. 7A and 7B, which illustrate example screenshots of a computing device 100 on which a GUI is displayed with individualized volume controls for video conferencing participants, in accordance with an embodiment of the present disclosure. As can be seen here, control of the volume for all (or some sub-set) of the audio streams of the video conferencing participants may be provided to a user, for example, via the on-screen GUI locally presented at a given endpoint device 100, in accordance with some embodiments. A user may locally control the volume of the individual audio stream associated with a given participant, for example, regardless of whether the video stream associated with that participant is featured in the Prominent Region or the Thumbnail Region of the on-screen GUI as presented at a given endpoint device 100.

In accordance with some embodiments, toggling of audio control options with respect to a given remote participant may be performed automatically and/or upon local input to endpoint device 100, such as by touch-based input (e.g., via a physical button, virtual button, etc.), gesture-based input, voice-based input, and/or a combination of any one or more thereof. In some instances, toggling on/off and adjustment of individualized volume control options may be provided, for example, by touching the region of the on-screen GUI as presented on device 100 (e.g., via a touch-sensitive display 130) in which the video stream associated with the participant of interest is displayed. In an example embodiment, the GUI may be configured to allow the user to locally control the audio stream associated with a given prominent participant (or other given participant of interest) while muting/attenuating noise coming through in the video conferencing session from other participant(s). In some instances, this may improve the quality of service (QoS) by reducing disturbing ambient noise. In some cases, use of individualized volume control may enhance interactive communication between the user and participants of interest (e.g., key speakers) in the video conferencing session. In some instances, use of individualized volume control may enhance the user experience by tailoring the video conferencing event in accordance with the user's preferences. In an example case, a given remote participant's voice in the audio stream incoming to the local endpoint device 100 can be adjusted (e.g., amplified; attenuated/muted) locally based on selected audio control(s).

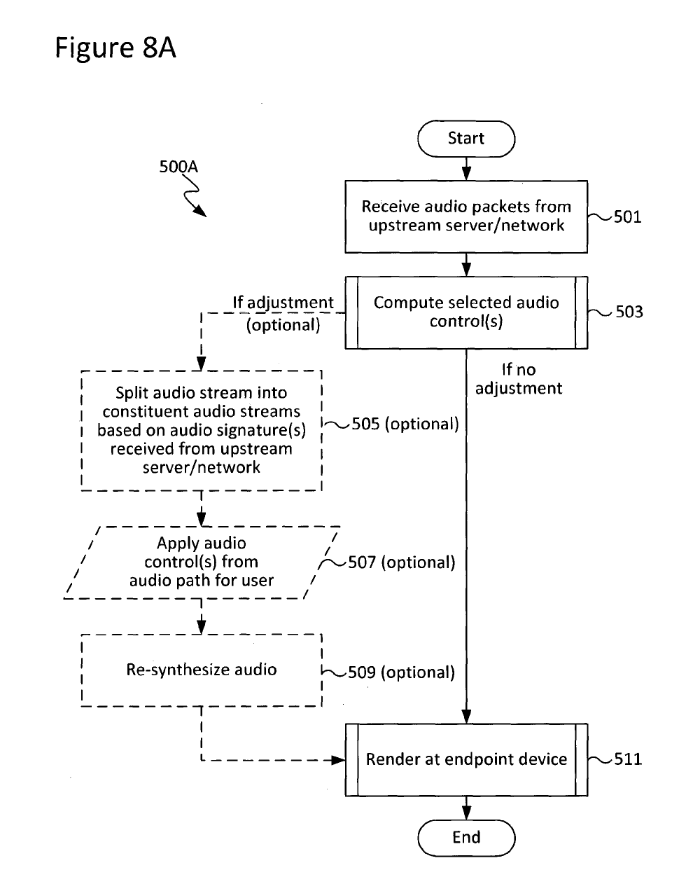

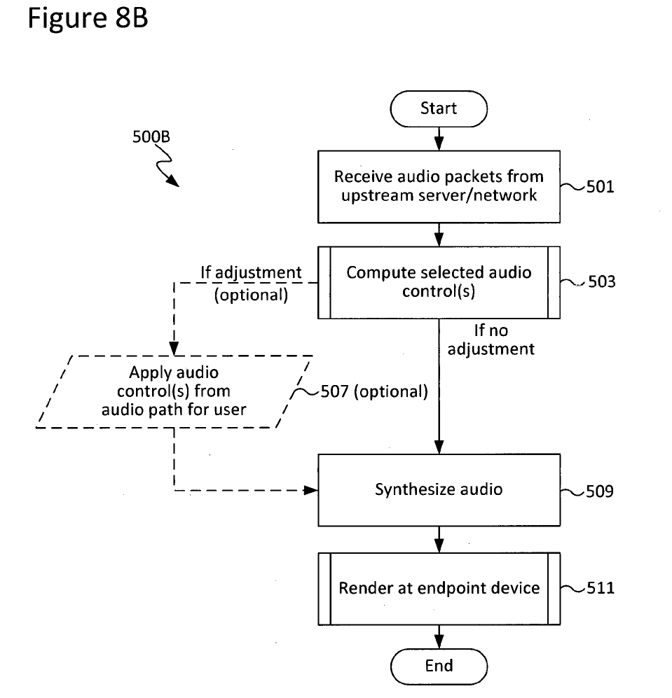

FIG. 8A is a flow diagram illustrating an IR.94-based implementation of individualized volume control, in accordance with an embodiment of the present disclosure. The flow 500A of FIG. 8A may be performed, in part or in whole, at a given endpoint device 100, in accordance with some embodiments. As can be seen, the flow 500A may begin as in block 501 with receiving, at a given endpoint device 100, audio packets from the upstream server/network 200 involved in the video conferencing session. The audio packets may include audio data from which the audio signature of a given participant of the video conferencing session may be computed, in accordance with some embodiments. Audio signature computation can be performed as typically done and may occur at periodic intervals, user-configurable intervals, or otherwise as frequently as desired for a given target application or end-use. In some cases, audio signature computation may be performed, for example, utilizing frequency transforms correlated with audio samples taken from the incoming audio stream(s) (e.g., via audio analysis module 160).

The flow 500A may continue as in block 503 with computing selected audio control(s) to be applied to the audio stream of a given participant. In accordance with some embodiments, the audio controls can be any standard and/or custom audio control/adjustment, as desired for a given target application or end-use, and may be selected automatically and/or based on user input. Selection of a given audio control may be provided, in part or in whole, via device 100 (e.g., via a touch-sensitive display 130; via an application 116), in accordance with some embodiments. User input may be, for example, touch-based (e.g., activation of a physical/virtual button), gesture-based, voice-based, and/or context/activity-based, among others.

If no adjustment is to be made to the audio stream associated with a given participant (e.g., based on the audio control(s) computed in block 503), then the flow 500A may progress from block 503 to block 511 with rendering the audio stream at the endpoint device 100 (e.g., via audio output device 170). If instead an adjustment is to be made, then the flow 500A optionally may progress from block 503 to block 505 with splitting the incoming audio stream based on the received audio signature(s) (e.g., received in the audio packets from the upstream server/network 200). The incoming audio stream may be filtered into multiple constituent audio streams, each corresponding to a given participant of the video conferencing session. In turn, each constituent audio stream may be analyzed, for example, utilizing the audio signature(s) in the audio packets received from the upstream server/network 200 (as in block 501) to identify which participant is associated with which constituent audio stream. Such analysis may be performed, for example, by audio analysis module 160, in accordance with some embodiments. In some embodiments, subtraction of a particular audio impulse from the incoming audio stream may be performed based on the audio signature received from the server/network 200 for each participant in the video conferencing session.

Thereafter, the flow 500A optionally may continue as in block 507 with applying the audio control(s) from the audio path for the user to the individual audio stream of interest and then as in block 509 with re-synthesizing the audio stream. More particularly, a given selected audio control may be applied to a given incoming audio stream to adjust that individual audio stream, in accordance with an embodiment. The constituent audio streams then may be re-synthesized into a single audio stream, for example, via endpoint device 100. Thereafter, the flow 500A may continue as in block 511 with rendering the resultant audio stream at the endpoint device 100 (e.g., via audio output device 170). In this manner, the audio stream of a given individual video conferencing participant may be adjusted based on user preferences or otherwise customized before re-synthesis and rendering, in accordance with some embodiments. As previously noted, such adjustment may be applied to a given individual audio stream automatically and/or upon user input, in accordance with some embodiments.

FIG. 8B is a flow diagram illustrating a WebRTC-based implementation of individualized volume control, in accordance with an embodiment of the present disclosure. The flow 500B of FIG. 8B may be performed, in part or in whole, at a given endpoint device 100, in accordance with some embodiments. As can be seen here, the flow 500B may begin as in block 501 and continue as in block 503 in the same manner as described above, for instance, with respect to FIG. 8A. If no adjustment is to be made to the audio stream associated with a given participant (e.g., based on the audio control(s) computed in block 503), then the flow 500B may continue as in block 509 with synthesizing the audio stream (e.g., if multiple individual audio streams are present) and then as in block 511 with rendering the resultant audio stream at the endpoint device 100 (e.g., via audio output device 170). If instead an adjustment is to be made, then the flow 500B optionally may progress from block 503 to block 507 with applying the audio control(s) from the audio path for the user to the individual audio stream of interest and then as in block 509 with synthesizing the audio stream (e.g., if multiple individual audio streams are present). More particularly, a given selected audio control may be applied to a given incoming audio stream to adjust that individual audio stream, in accordance with an embodiment. The individual audio stream(s) then may be synthesized into a single audio stream, for example, via endpoint device 100. Thereafter, the flow 500B may continue as in block 511 with rendering the resultant audio stream at the endpoint device 100 (e.g., via audio output device 170). In this manner, the audio stream of a given individual video conferencing participant may be adjusted based on user preferences or otherwise customized before synthesis and rendering, in accordance with some embodiments. As previously noted, such adjustment may be applied to a given individual audio stream automatically and/or upon user input, in accordance with some embodiments. As compared to the IR.94-based flow 500A of FIG. 8A, the WebRTC-based flow 500B of FIG. 8B may omit audio stream splitting as in block 505 because the individual audio streams received by endpoint device 100 in the WebRTC-based flow 500B may be already separated given that they may come from separate source devices 100.

A given video conferencing session may be started as either IR.94-based or WebRTC-based, and the appropriate flow (e.g., FIG. 8A or FIG. 8B) for individualized volume control may be enforced accordingly, in accordance with some embodiments. As will be appreciated in light of this disclosure, in an IR.94-based session, a given user may have the ability to make a request for individualized volume control that impacts other users in the video conferencing session, in accordance with an embodiment. As will be further appreciated, in a WebRTC-based session, a given user's request for individualized volume control may not impact other users in the video conferencing session, in accordance with an embodiment. In a more general sense, the level of user control for individualized volume control within a given video conferencing session may depend, at least in part, on whether the session is IR.94-based or WebRTC-based, in some embodiments.

Numerous variations on the methodologies of FIGS. 8A and 8B will be apparent in light of this disclosure. As will be appreciated, and in accordance with some embodiments, each of the functional boxes (e.g., 501; 503; 505; 507; 509; 511) shown in FIGS. 8A and 8B can be implemented, for example, as a module or sub-module that, when executed by one or more processors 120 or otherwise operated, causes the associated functionality as described herein to be carried out. The modules/sub-modules may be implemented, for instance, in software (e.g., executable instructions stored on one or more computer readable media), firmware (e.g., embedded routines of a microcontroller or other device which may have I/O capacity for soliciting input from a user and providing responses to user requests), and/or hardware (e.g., gate level logic, field-programmable gate array, purpose-built silicon, etc.).

In accordance with some embodiments, the video stream associated with a given participant may remain substantially unchanged while carrying out an IR.94-based implementation (e.g., flow 500A of FIG. 8A) or a WebRTC-based implementation (e.g., flow 500B of FIG. 8B) of individualized volume control, as described herein. However, in accordance with some embodiments, any graphics associated with the individualized volume control of a given participant (e.g., virtual toggle button, virtual slider bar, or other suitable volume adjustment feature) may be generated by the endpoint device 100, synthesized with the incoming video stream, and rendered as part of the GUI presented at display 130 of that device 100. In an example case, the representative video stream of a given participant displayed in the GUI may be overlaid with one or more volume control-related graphics (e.g., such as can be seen in FIGS. 7A and 7B, for instance).

In accordance with some embodiments, operations associated with individualized volume control (as described herein) can be implemented, for example, at the hardware level (e.g., SOC design) and/or at the service provider level, as desired for a given target application or end-use. In some cases, operations associated with individualized volume control may involve only destination-side processing (e.g., at a given endpoint device 100) and may not involve any (or otherwise may involve only minimal) source-side processing (e.g., at a service provider server/network 200 and/or at a given source device 100). In accordance with some embodiments, operations associated with individualized volume control may be implemented, for example, at point 205 of the flow of FIG. 2. Other suitable implementations of individualized volume control, as described herein, will depend on a given application and will be apparent in light of this disclosure.

Adaptive Video Capture and Processing

In accordance with some embodiments, the resolution and/or frame rate of video data captured at a source device involved in a video conferencing session may be adaptively varied, for example, during capture and/or processing before encoding. Such adaptive adjustments may be based, in part or in whole, on the detected audio activity level of the user of the source device 100, in accordance with some embodiments. More particularly, under this adaptive capture and processing scheme, the detected audio activity level of a given participant may be analyzed at his/her source device 100 (e.g., via audio analysis module 160) and, in accordance with some embodiments: (1) the capture resolution and/or capture frame rate of the image capture device 180 of the source device 100 may be varied (e.g., increased; decreased) to adjust the resolution and/or frame rate of video data captured thereby; and/or (2) the video data captured by image capture device 180 of the source device 100 may be processed (e.g., upscaled; downscaled) to vary its resolution and/or frame rate. Such adaptive adjustments to the resolution and/or frame rate based on audio analysis results may be performed, in accordance with some embodiments, before transmission of the resultant encoded uplink video to a server/network 200 and any downstream endpoint device(s) 100. In some cases, if the capture resolution and/or capture frame rate are varied, then scaling of the captured video data optionally may be forgone during subsequent pre-encoding processing. In some other cases, if the capture resolution and/or capture frame rate are fixed, then the captured video data optionally may undergo scaling during subsequent pre-encoding processing. Numerous variations will be apparent in light of this disclosure.

In accordance with some embodiments, under the disclosed adaptive capture and processing scheme, a given source device 100 initially may output captured video data of an intermediate quality level (e.g., at some intermediate resolution and/or frame rate), which may be standard, arbitrary, or user-configurable, as desired. Thereafter, the audio input of the user of that device 100 may be analyzed (e.g., via audio analysis module 160 at the source device 100) to determine that user's audio activity level, in accordance with some embodiments. Based on the user's detected audio activity level, the resolution and/or frame rate of the video stream associated with that participant may be adaptively adjusted at source device 100 (e.g., by adjusting the capture resolution and/or capture frame rate; by upscaling/downscaling captured video data), in accordance with some embodiments, as follows:

| Audio Activity Level | Resolution | Frame Rate |
|---|---|---|
| Audio Activity State A0 | QCIF | 1 fps |
| Audio Activity State A1 | VGA | 15 fps |
| Audio Activity State A2 | 720p | 30 fps |

It should be noted, however, that the present disclosure is not so limited to only these example resolutions and frame rates, as in a more general sense, and in accordance with some embodiments, the resolution and frame rate of video data captured and processed by a given source device 100 may be customized, as desired for a given target application or end-use.

In accordance with some embodiments, if the user's audio activity level sufficiently decreases (e.g., falls below a given audio threshold of interest), then the resolution and/or frame rate for video data captured at the user's source device 100 may be reduced (e.g., captured at a reduced resolution and/or frame rate; downscaled or otherwise processed to reduce resolution and/or frame rate) accordingly before encoding and transmission. Contrariwise, if the user's audio activity level sufficiently increases (e.g., rises above a given audio threshold of interest), then the resolution and/or frame rate for video data captured at the user's source device 100 may be increased (e.g., captured at an increased resolution and/or frame rate; upscaled or otherwise processed to increase resolution and/or frame rate) accordingly before encoding and transmission, in accordance with some embodiments.

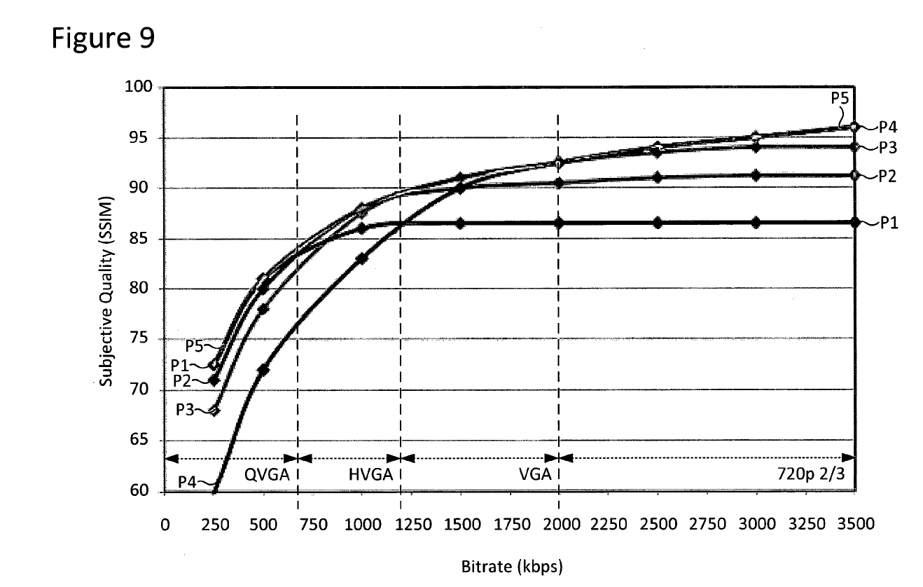

In some cases, the disclosed adaptive video data capture and processing scheme may be utilized, for example, to provide for: (1) a reduction in transmission bandwidth for a given transmitting participant (e.g., at a given source device 100); and/or (2) a reduction in overall communication bandwidth for all or some sub-set of participants of the video conferencing session (e.g., at endpoint devices 100). FIG. 9 is a graph showing subjective quality (SSIM) as a function of resolution and bitrate. Within this graph: plot P1 is representative of quarter VGA (QVGA) (320×240) resolution; plot P2 is representative of half-size VGA (HVGA) (480×320) resolution; plot P3 is representative of video graphics array (VGA) (640×480) resolution; plot P4 is representative of 720p 3:2 (720×480) resolution; and plot P5 is representative of an example target (e.g., optimal) resolution. As can be seen from these plots, subjective quality changes with both resolution and bitrate. The plots P1-P5 of FIG. 9 demonstrate the quality versus resolution and bitrate reduction that can be provided, for example, utilizing the disclosed adaptive video capture and processing scheme at a given source device 100, in accordance with some embodiments.

In some instances, the disclosed adaptive capture and processing scheme may be utilized, for example, to reduce transmission bandwidth in instances in which a participant is idle (e.g., Audio Activity State A0) or otherwise has a low audio activity level (e.g., Audio Activity State A1). In some cases, the disclosed scheme may be utilized, for instance, to reduce the amount of video data that is ultimately distributed to the endpoint device(s) 100 involved in the video conferencing session. In some instances, the disclosed scheme may be utilized, for example, to optimally use network bandwidth for video conferencing participants having a sufficiently high audio activity level (e.g., Audio Activity State A2). In some such instances, the optimality of network bandwidth usage may be focused, for example, on providing comparatively better video quality at a given bandwidth. In some other such instances, the optimality of network bandwidth usage may be focused, for example, on minimizing bandwidth for a given video quality. Thus, in a general sense, the disclosed adaptive video data capture and processing scheme may be considered bandwidth-controlled in some embodiments.

In some cases, the disclosed scheme may be utilized, for example, to reduce resource usage for video conferencing participants having a sufficiently low audio activity level (e.g., Audio Activity States A0 and A1). In some cases, application of the disclosed scheme may be performed, for example, to accommodate instances in which low power usage is desired. It should be noted, however, that the present disclosure is not so limited only to optimization of bandwidth and/or resource usage, as in a more general sense, and in accordance with some embodiments, the disclosed adaptive capture and processing scheme may be utilized to reduce, optimize, or otherwise customize bandwidth usage and/or resource usage, as desired for a given target application or end-use. For example, if a server/network 200 is congested, then for those inactive video conferencing participants (e.g., Audio Activity States A0 and A1), the resolution and/or frame rate for their video streams may be reduced or otherwise adjusted at their source devices 100 in effort to reduce their contribution to bandwidth consumption, whereas the active video conferencing participants (e.g., Audio Activity State A2) may retain a comparatively higher resolution and/or frame rate, as desired for a given target application or end-use.

In some instances, the disclosed adaptive capture and processing scheme may provide for real-time adaptive video encoding options which can benefit source devices 100, server/network 200, and/or endpoint devices 100. For example, in some cases, use of the disclosed scheme may minimize or otherwise reduce wasted video data transfer from a given source device 100 to the server/network 200 and/or to downstream endpoint device(s) 100. In some instances, an improvement in quality of service (QoS) may be realized utilizing the disclosed scheme. In some cases, application of the disclosed scheme may simplify uplink encoding and lower transmission bandwidth utilized for sending a video stream over a server/network 200. In some instances, application of the disclosed scheme may provide for optimization or other customization of power usage by a given device 100 involved in the video conferencing session.

In some cases, analysis of a participant's audio activity level via application of one or more audio thresholds of interest may serve to provide a given downstream user with feedback (e.g., by way of observing the quality of his/her video stream at an endpoint device 100) as to whether he/she is or is not classified as an active participant within the context of the video conferencing session. In some instances, use of the disclosed adaptive video data capture and processing scheme may realize improvements, for example, in network bandwidth, processing time, and/or resource usage as compared to existing video conferencing programs. For instance, in an example case, a reduction in bandwidth of about 40% (e.g., ±10%) may be provided utilizing the disclosed adaptive video data capture and processing scheme. In another example case, an improvement in battery power usage of about 30% (e.g., ±10%) may be provided utilizing the disclosed adaptive video data capture and processing scheme.

In accordance with some embodiments, operations associated with adaptive video data capture and processing (as described herein) can be implemented, for example, at the hardware level (e.g., SOC design) and/or at the service provider level, as desired for a given target application or end-use, in accordance with some embodiments. In some cases, operations associated with adaptive video data capture and processing may involve only source-side processing (e.g., at a given source device 100) and may benefit destination-side processing (e.g., at a downstream service provider server/network 200 and/or at a downstream source device 100). In accordance with some embodiments, operations associated with adaptive video data capture and processing may be implemented, for example, at point 207 of the flow of FIG. 2. Other suitable implementations of the adaptive video data capture and processing scheme, as described herein, will depend on a given application and will be apparent in light of this disclosure.

Example System

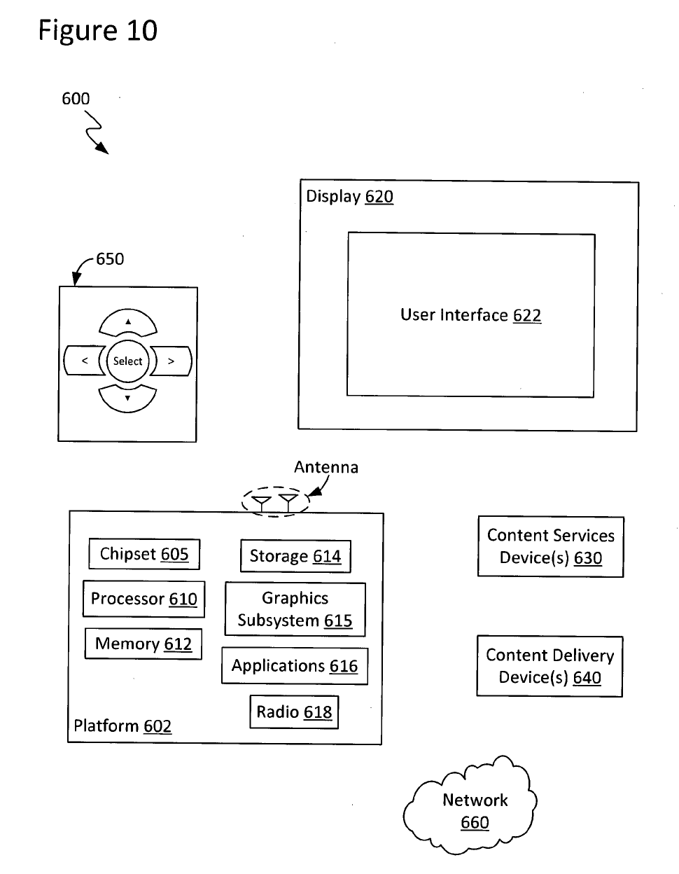

FIG. 10 illustrates an example system 600 that may carry out the techniques for enhancing user experience in video conferencing as described herein, in accordance with some embodiments. In some embodiments, system 600 may be a media system, although system 600 is not limited to this context. For example, system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, set-top box, game console, or other such computing environments capable of performing graphics rendering operations.

In some embodiments, system 600 comprises a platform 602 coupled to a display 620. Platform 602 may receive content from a content device such as content services device(s) 630 or content delivery device(s) 640 or other similar content sources. A navigation controller 650 comprising one or more navigation features may be used to interact, for example, with platform 602 and/or display 620. Each of these example components is described in more detail below.

In some embodiments, platform 602 may comprise any combination of a chipset 605, processor 610, memory 612, storage 614, graphics subsystem 615, applications 616, and/or radio 618. Chipset 605 may provide intercommunication among processor 610, memory 612, storage 614, graphics subsystem 615, applications 616, and/or radio 618. For example, chipset 605 may include a storage adapter (not depicted) capable of providing intercommunication with storage 614.

Processor 610 may be implemented, for example, as Complex Instruction Set Computer (CISC) or Reduced Instruction Set Computer (RISC) processors, x86 instruction set compatible processors, multi-core, or any other microprocessor or central processing unit (CPU). In some embodiments, processor 610 may comprise dual-core processor(s), dual-core mobile processor(s), and so forth. Memory 612 may be implemented, for instance, as a volatile memory device such as, but not limited to, a Random Access Memory (RAM), Dynamic Random Access Memory (DRAM), or Static RAM (SRAM). Storage 614 may be implemented, for example, as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In some embodiments, storage 614 may comprise technology to increase the storage performance enhanced protection for valuable digital media when multiple hard drives are included, for example.

Graphics subsystem 615 may perform processing of images such as still or video for display. Graphics subsystem 615 may be a graphics processing unit (GPU) or a visual processing unit (VPU), for example. An analog or digital interface may be used to communicatively couple graphics subsystem 615 and display 620. For example, the interface may be any of a High-Definition Multimedia Interface (HDMI), DisplayPort, wireless HDMI, and/or wireless HD compliant techniques. Graphics subsystem 615 could be integrated into processor 610 or chipset 605. Graphics subsystem 615 could be a stand-alone card communicatively coupled to chipset 605. The techniques for enhancing user experience in video conferencing described herein may be implemented in various hardware architectures. For example, the techniques for enhancing user experience in video conferencing as provided herein may be integrated within a graphics and/or video chipset. Alternatively, a discrete security processor may be used. In still another embodiment, the graphics and/or video functions including the techniques for enhancing user experience in video conferencing may be implemented by a general purpose processor, including a multi-core processor.

Radio 618 may include one or more radios capable of transmitting and receiving signals using various suitable wireless communications techniques. Such techniques may involve communications across one or more wireless networks. Exemplary wireless networks may include, but are not limited to, wireless local area networks (WLANs), wireless personal area networks (WPANs), wireless metropolitan area network (WMANs), cellular networks, and satellite networks. In communicating across such networks, radio 618 may operate in accordance with one or more applicable standards in any version.

In some embodiments, display 620 may comprise any television or computer-type monitor or display. Display 620 may comprise, for example, a liquid crystal display (LCD) screen, electrophoretic display (EPD) or liquid paper display, flat panel display, touchscreen display, television-like device, and/or a television. Display 620 may be digital and/or analog. In some embodiments, display 620 may be a holographic or three-dimensional (3-D) display. Also, display 620 may be a transparent surface that may receive a visual projection. Such projections may convey various forms of information, images, and/or objects. For example, such projections may be a visual overlay for a mobile augmented reality (MAR) application. Under the control of one or more software applications 616, platform 602 may display a user interface 622 on display 620.

In some embodiments, content services device(s) 630 may be hosted by any national, international, and/or independent service and thus may be accessible to platform 602 via the Internet or other network, for example. Content services device(s) 630 may be coupled to platform 602 and/or to display 620. Platform 602 and/or content services device(s) 630 may be coupled to a network 660 to communicate (e.g., send and/or receive) media information to and from network 660. Content delivery device(s) 640 also may be coupled to platform 602 and/or to display 620. In some embodiments, content services device(s) 630 may comprise a cable television box, personal computer (PC), network, telephone, Internet-enabled devices or appliance capable of delivering digital information and/or content, and any other similar device capable of unidirectionally or bi-directionally communicating content between content providers and platform 602 and/or display 620, via network 660 or directly. It will be appreciated that the content may be communicated unidirectionally and/or bi-directionally to and from any one of the components in system 600 and a content provider via network 660. Examples of content may include any media information including, for example, video, music, graphics, text, medical and gaming content, and so forth.

Content services device(s) 630 receives content such as cable television programming including media information, digital information, and/or other content. Examples of content providers may include any cable or satellite television or radio or Internet content providers. The provided examples are not meant to limit the present disclosure. In some embodiments, platform 602 may receive control signals from navigation controller 650 having one or more navigation features. The navigation features of controller 650 may be used to interact with user interface 622, for example. In some embodiments, navigation controller 650 may be a pointing device that may be a computer hardware component (specifically human interface device) that allows a user to input spatial (e.g., continuous and multi-dimensional) data into a computer. Many systems such as graphical user interfaces (GUI) and televisions and monitors allow the user to control and provide data to the computer or television using physical gestures.

Movements of the navigation features of controller 650 may be echoed on a display (e.g., display 620) by movements of a pointer, cursor, focus ring, or other visual indicators displayed on the display. For example, under the control of software applications 716, the navigation features located on navigation controller 650 may be mapped to virtual navigation features displayed on user interface 622, for example. In some embodiments, controller 650 may not be a separate component but integrated into platform 602 and/or display 620. Embodiments, however, are not limited to the elements or in the context shown or described herein, as will be appreciated.

In some embodiments, drivers (not shown) may comprise technology to enable users to instantly turn on and off platform 602 like a television with the touch of a button after initial boot-up, when enabled, for example. Program logic may allow platform 602 to stream content to media adaptors or other content services device(s) 630 or content delivery device(s) 640 when the platform is turned “off” In addition, chip set 605 may comprise hardware and/or software support for 5.1 surround sound audio and/or high definition 7.1 surround sound audio, for example. Drivers may include a graphics driver for integrated graphics platforms. In some embodiments, the graphics driver may comprise a peripheral component interconnect (PCI) express graphics card.

In various embodiments, any one or more of the components shown in system 600 may be integrated. For example, platform 602 and content services device(s) 630 may be integrated, or platform 602 and content delivery device(s) 640 may be integrated, or platform 602, content services device(s) 630, and content delivery device(s) 640 may be integrated, for example. In various embodiments, platform 602 and display 620 may be an integrated unit. Display 620 and content service device(s) 630 may be integrated, or display 620 and content delivery device(s) 640 may be integrated, for example. These examples are not meant to limit the present disclosure.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the radio frequency (RF) spectrum and so forth. When implemented as a wired system, system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 602 may establish one or more logical or physical channels to communicate information. The information may include media information and control information. Media information may refer to any data representing content meant for a user. Examples of content may include, for example, data from a voice conversation, video conference, streaming video, email or text messages, voice mail message, alphanumeric symbols, graphics, image, video, text and so forth. Control information may refer to any data representing commands, instructions, or control words meant for an automated system. For example, control information may be used to route media information through a system or instruct a node to process the media information in a predetermined manner (e.g., using the techniques for enhancing user experience in video conferencing as described herein). The embodiments, however, are not limited to the elements or context shown or described in FIG. 10.

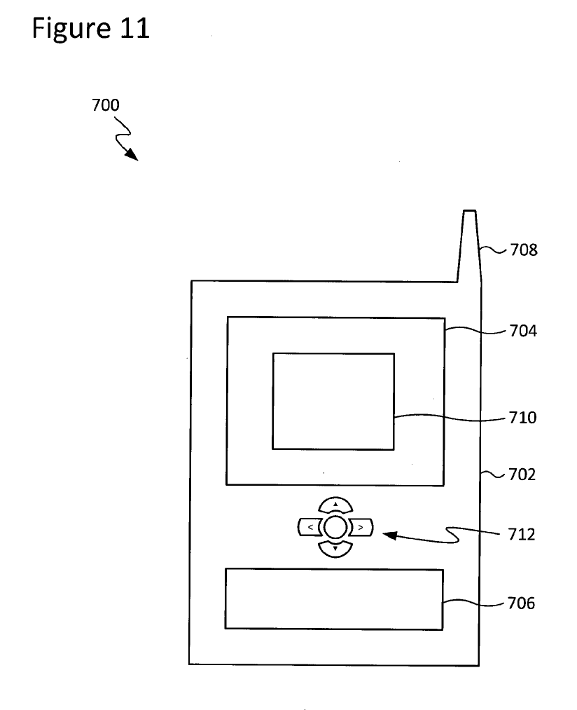

As described above, system 600 may be embodied in varying physical styles or form factors. FIG. 11 illustrates embodiments of a small form factor device 700 in which system 600 may be embodied. In some embodiments, for example, device 700 may be implemented as a mobile computing device having wireless capabilities. A mobile computing device may refer to any device having a processing system and a mobile power source or supply, such as one or more batteries, for example.

As previously described, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In some embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 11, device 700 may comprise a housing 702, a display 704, an input/output (I/O) device 706, and an antenna 708. Device 700 may include a user interface (UI) 710. Device 700 also may comprise navigation features 712. Display 704 may comprise any suitable display unit for displaying information appropriate for a mobile computing device. I/O device 706 may comprise any suitable I/O device for entering information into a mobile computing device. Examples for I/O device 706 may include an alphanumeric keyboard, a numeric keypad, a touch pad, input keys, buttons, switches, rocker switches, microphones, speakers, voice recognition device and software, and so forth. Information also may be entered into device 700 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits (IC), application specific integrated circuits (ASIC), programmable logic devices (PLD), digital signal processors (DSP), field-programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Whether hardware elements and/or software elements are used may vary from one embodiment to the next in accordance with any number of factors, such as desired computational rate, power levels, heat tolerances, processing cycle budget, input data rates, output data rates, memory resources, data bus speeds, and other design or performance constraints.

Some embodiments may be implemented, for example, using a machine-readable medium or article which may store an instruction or a set of instructions that, if executed by a machine, may cause the machine to perform a method and/or operations in accordance with an embodiment. Such a machine may include, for example, any suitable processing platform, computing platform, computing device, processing device, computing system, processing system, computer, processor, or the like, and may be implemented using any suitable combination of hardware and software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of executable code implemented using any suitable high-level, low-level, object-oriented, visual, compiled, and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers, or other such information storage, transmission, or displays. The embodiments are not limited in this context.

### Further Example Embodiments

The following examples pertain to further embodiments, from which numerous permutations and configurations will be apparent.

Example 1 is a system including: a processor; a memory communicatively coupled with the processor; an audio analysis module configured to analyze audio data received in a video conferencing session and to determine therefrom an audio activity level of at least one participant of the video conferencing session; and a user interface (UI) module configured to at least one of: adjust a video composition of a graphical user interface (GUI) locally presented by the system based on the audio activity level of a remote participant; adjust a video composition of a GUI locally presented by the system based on input by a local participant; adjust a volume level of a locally presented audio stream associated with a remote participant based on input by a local participant; and automatically adjust at least one of a resolution and a frame rate of video data transmitted by the system based on the audio activity level of a local participant.

Example 2 includes the subject matter of any of Examples 1 and 3-9, wherein to determine the audio activity level of the at least one participant, the audio analysis module is configured to: sample the audio data received in the video conferencing session and compute therefrom an audio signature to identify which participant is associated with the audio data; and compare the audio data against an audio threshold.

Example 3 includes the subject matter of Example 2, wherein the audio threshold includes at least one of a volume level value and a duration value.

Example 4 includes the subject matter of Example 2, wherein the audio threshold is user-configurable.

Example 5 includes the subject matter of any of Examples 1-4 and 6-9, wherein the UI module is configured to perform at least three of the four adjustments.

Example 6 includes the subject matter of any of Examples 1-5 and 7-9 and further includes: a touch-sensitive display, wherein the GUI is presented on the touch-sensitive display, and wherein the UI module is configured to adjust the video composition of the GUI based on input received via the touch-sensitive display.

Example 7 includes the subject matter of any of Examples 1-6 and 8-9, wherein the system includes at least one of a laptop/notebook computer, a sub-notebook computer, a tablet computer, a mobile phone, a smartphone, a personal digital assistant (PDA), a portable media player (PMP), a cellular handset, a handheld gaming device, a gaming platform, a desktop computer, a television set, a video conferencing system, and a server configured to host a video conferencing session.

Example 8 includes the subject matter of any of Examples 1-7 and 9, wherein the video composition is adjusted by increasing a prominence of a remote participant when that participant is actively participating in the video conferencing session or decreasing a prominence of a remote participant when that participant is not actively participating in the video conferencing session.

Example 9 includes the subject matter of any of Examples 1-8, wherein the audio analysis module is configured to analyze the audio data at a user-configurable interval.

Example 10 is a non-transitory computer program product encoded with instructions that, when executed by one or more processors, causes a process to be carried out, the process including: receiving audio data in a video conferencing session; analyzing the audio data to determine an audio activity level of at least one participant of the video conferencing session; and adjusting a video composition of a graphical user interface (GUI) based on the audio activity level of the at least one participant.

Example 11 includes the subject matter of any of Examples 10 and 12-22, wherein analyzing the audio data to determine the audio activity level of the at least one participant includes: sampling the audio data received in the video conferencing session and computing therefrom an audio signature to identify which participant is associated with the audio data; and comparing the audio data against an audio threshold.

Example 12 includes the subject matter of Example 11, wherein upon comparing the audio data against the audio threshold, if the audio data exceeds the audio threshold, then adjusting the video composition of the GUI includes: automatically transitioning presentation of a video stream representative of the participant from a thumbnail region of the GUI to a prominent region of the GUI; automatically transitioning presentation of a video stream representative of the participant from a thumbnail region of the GUI to a prominent region of the GUI and automatically transitioning presentation of a video stream representative of another participant from the prominent region of the GUI to the thumbnail region of the GUI; or maintaining presentation of a video stream representative of the participant within a prominent region of the GUI.

Example 13 includes the subject matter of Example 11, wherein upon comparing the audio data against the audio threshold, if the audio data does not exceed the audio threshold, then adjusting the video composition of the GUI includes: automatically transitioning presentation of a video stream representative of the participant from a prominent region of the GUI to a thumbnail region of the GUI; or maintaining presentation of a video stream representative of the participant within a thumbnail region of the GUI.

Example 14 includes the subject matter of Example 11, wherein the audio threshold includes at least one of a volume level value and a duration value.

Example 15 includes the subject matter of Example 11, wherein the audio threshold is user-configurable.

Example 16 includes the subject matter of any of Examples 10-15 and 17-22, wherein adjusting the video composition of the GUI includes at least one of: transitioning presentation of a video stream representative of at least one of a remote participant and an object/scene of interest between a prominent region of the GUI and a thumbnail region of the GUI; adjusting a resolution of a video stream representative of at least one remote participant; and adjusting a frame rate of a video stream representative of at least one remote participant.

Example 17 includes the subject matter of any of Examples 10-16 and 18-22, wherein adjusting the video composition of the GUI is performed automatically based on the audio activity level of a local or remote participant causing the adjusting.

Example 18 includes the subject matter of any of Examples 10-17 and 19-22, wherein adjusting the video composition of the GUI is further based on input received via a touch-sensitive display on which the GUI is presented.

Example 19 includes the subject matter of any of Examples 10-18 and 20-22, wherein adjusting the video composition of the GUI is performed in real time.

Example 20 includes the subject matter of any of Examples 10-19 and 21-22, wherein analyzing the audio data to determine the audio activity level of the at least one participant is performed at a user-configurable interval.

Example 21 includes the subject matter of any of Examples 10-20, wherein at least a portion of the process is carried out via an IR.94-based implementation.

Example 22 includes the subject matter of any of Examples 10-20, wherein at least a portion of the process is carried out via a WebRTC-based implementation.

Example 23 is a non-transitory computer program product encoded with instructions that, when executed by one or more processors, causes a process to be carried out, the process including: receiving audio data in a video conferencing session, the audio data including at least one audio stream associated with an individual remote video conferencing participant; and adjusting a volume level of the at least one audio stream associated with the individual remote video conferencing participant.

Example 24 includes the subject matter of any of Examples 23 and 25-28, wherein the process further includes: adjusting a video composition of a graphical user interface (GUI) to include a volume control feature associated with the individual remote video conferencing participant.

Example 25 includes the subject matter of any of Examples 23-24, wherein at least a portion of the process is carried out via a WebRTC-based implementation.

Example 26 includes the subject matter of any of Examples 23-24 and 27-28, wherein prior to adjusting the volume level of the at least one audio stream associated with the individual remote video conferencing participant, the process further includes: splitting the audio data into a plurality of audio streams, the plurality including the at least one audio stream associated with the individual remote video conferencing participant.

Example 27 includes the subject matter of Example 26, wherein after adjusting the volume level of the at least one audio stream associated with the individual remote video conferencing participant, the process further includes: re-synthesizing the plurality of audio streams into a single audio stream.

Example 28 includes the subject matter of any of Examples 23-24 and 26-27, wherein at least a portion of the process is carried out via an IR.94-based implementation.

Example 29 is a non-transitory computer program product encoded with instructions that, when executed by one or more processors, causes a process to be carried out, the process including: receiving audio data in a video conferencing session; analyzing the audio data to determine therefrom an audio activity level of a local participant of the video conferencing session; and adjusting at least one of a resolution and a frame rate of video data transmitted in the video conferencing session based on the audio activity level of the local participant.

Example 30 includes the subject matter of any of Examples 29 and 31-41, wherein adjusting at least one of the resolution and the frame rate of the video data transmitted in the video conferencing session includes: adjusting at least one of a capture resolution and a capture frame rate of an image capture device configured to capture the video data before encoding thereof.

Example 31 includes the subject matter of any of Examples 29-30 and 32-41, wherein adjusting at least one of the resolution and the frame rate of the video data transmitted in the video conferencing session includes: scaling at least one of the resolution and the frame rate of captured video data before encoding thereof.

Example 32 includes the subject matter of any of Examples 29-31 and 33-41, wherein analyzing the audio data to determine therefrom the audio activity level of the local participant includes: sampling the audio data received in the video conferencing session and computing therefrom an audio signature to identify which participant is associated with the audio data; and comparing the audio data against an audio threshold.

Example 33 includes the subject matter of Example 32, wherein upon comparing the audio data against the audio threshold, if the audio data exceeds the audio threshold, then adjusting at least one of the resolution and the frame rate of the video data includes at least one of: automatically increasing at least one of a capture resolution and a capture frame rate of an image capture device configured to capture the video data before encoding thereof; and automatically upscaling at least one of the resolution and the frame rate of the video data before encoding thereof.

Example 34 includes the subject matter of Example 32, wherein upon comparing the audio data against the audio threshold, if the audio data does not exceed the audio threshold, then adjusting at least one of the resolution and the frame rate of the video data includes at least one of: automatically decreasing at least one of a capture resolution and a capture frame rate of an image capture device configured to capture the video data before encoding thereof; and automatically downscaling at least one of the resolution and the frame rate of the video data before encoding thereof.

Example 35 includes the subject matter of Example 32, wherein the audio threshold includes at least one of a volume level value and a duration value.

Example 36 includes the subject matter of Example 32, wherein the audio threshold is user-configurable.

Example 37 includes the subject matter of Example 32, wherein the video data is provided by a still camera or a video camera.

Example 38 includes the subject matter of Example 32, wherein adjusting at least one of the resolution and the frame rate of the video data is performed in real time.

Example 39 includes the subject matter of any of Examples 29-38 and 40-41, wherein analyzing the audio data to determine therefrom an audio activity level of a local participant of the video conferencing session is performed at a user-configurable interval.

Example 40 includes the subject matter of any of Examples 29-39, wherein at least a portion of the process is carried out via an IR.94-based implementation.

Example 41 includes the subject matter of any of Examples 29-39, wherein at least a portion of the process is carried out via a WebRTC-based implementation.

Example 42 is a non-transitory computer program product encoded with instructions that, when executed by one or more processors, causes a process to be carried out, the process including: receiving video data in a video conferencing session; and adjusting a video composition of a graphical user interface (GUI) based on input by a local participant.

Example 43 includes the subject matter of any of Examples 42 and 44-49, wherein adjusting the video composition of the GUI includes: locating a prominent region and a thumbnail region within the GUI; splitting the video data into a plurality of video streams including at least a first video stream for the prominent region and a second video stream for the thumbnail region; and recomposing the plurality of video streams into a single video stream based on the input of the local participant.

Example 44 includes the subject matter of any of Examples 42-43 and 45-49, wherein adjusting the video composition of the GUI includes: transitioning presentation of a video stream representative of a remote participant from a thumbnail region of the GUI to a prominent region of the GUI; or maintaining presentation of a video stream representative of the remote participant within a prominent region of the GUI.

Example 45 includes the subject matter of any of Examples 42-44 and 46-49, wherein adjusting the video composition of the GUI includes: transitioning presentation of a video stream representative of a remote participant from a prominent region of the GUI to a thumbnail region of the GUI; or maintaining presentation of a video stream representative of the remote participant within a thumbnail region of the GUI.

Example 46 includes the subject matter of any of Examples 42-45 and 47-49, wherein adjusting the video composition of the GUI includes: adjusting at least one of a resolution and a frame rate of a video stream representative of a remote participant presented locally via the GUI.

Example 47 includes the subject matter of any of Examples 42-46 and 48-49, wherein adjusting the video composition of the GUI is performed in real time.

Example 48 includes the subject matter of any of Examples 42-47, wherein at least a portion of the process is carried out via an IR.94-based implementation.

Example 49 includes the subject matter of any of Examples 42-47, wherein at least a portion of the process is carried out via a WebRTC-based implementation.

Example 50 is a method of enhancing user experience in a video conferencing session, the method including: analyzing audio data received in the video conferencing session; determining from the received audio data an audio activity level of at least one participant of the video conferencing session; and at least one of: adjusting a video composition of a locally presented graphical user interface (GUI) based on the audio activity level of a remote participant; adjusting a video composition of a locally presented GUI based on input by a local participant; adjusting a volume level of a locally presented audio stream associated with a remote participant based on input by a local participant; and automatically adjusting at least one of a resolution and a frame rate of video data transmitted in the video conferencing session based on the audio activity level of a local participant.

Example 51 includes the subject matter of any of Examples 50 and 52-66, wherein adjusting the video composition of the GUI includes: automatically transitioning presentation of a video stream representative of the participant from a thumbnail region of the GUI to a prominent region of the GUI; or maintaining presentation of a video stream representative of the participant within a prominent region of the GUI.

Example 52 includes the subject matter of any of Examples 50-51 and 53-66, wherein adjusting the video composition of the GUI includes: automatically transitioning presentation of a video stream representative of the participant from a prominent region of the GUI to a thumbnail region of the GUI; or maintaining presentation of a video stream representative of the participant within a thumbnail region of the GUI.

Example 53 includes the subject matter of any of Examples 50-52 and 54-66, wherein adjusting the video composition of the GUI is performed automatically.

Example 54 includes the subject matter of any of Examples 50-53 and 55-66, wherein adjusting the video composition of the GUI is further based on input received via the GUI.

Example 55 includes the subject matter of any of Examples 50-54 and 56-66, wherein adjusting the video composition of the GUI is performed in real time.

Example 56 includes the subject matter of any of Examples 50-55 and 57-66, wherein adjusting the volume level of the locally presented audio stream includes amplifying the volume level.

Example 57 includes the subject matter of any of Examples 50-56 and 58-66, wherein adjusting the volume level of the locally presented audio stream includes attenuating the volume level.

Example 58 includes the subject matter of any of Examples 50-57 and 59-66, wherein adjusting at least one of the resolution and the frame rate of the video data includes at least one of: increasing at least one of a capture resolution and a capture frame rate of an image capture device configured to capture the video data before encoding thereof; and upscaling at least one of the resolution and the frame rate of the video data before encoding thereof.

Example 59 includes the subject matter of any of Examples 50-58 and 60-66, wherein adjusting at least one of the resolution and the frame rate of the video data includes at least one of: decreasing at least one of a capture resolution and a capture frame rate of an image capture device configured to capture the video data before encoding thereof; and downscaling at least one of the resolution and the frame rate of the video data before encoding thereof.

Example 60 includes the subject matter of any of Examples 50-59 and 61-66, wherein analyzing the audio data to determine therefrom the audio activity level of the at least one participant includes: sampling the audio data received in the video conferencing session and computing therefrom an audio signature to identify which participant is associated with the audio data; and comparing the audio data against an audio threshold.

Example 61 includes the subject matter of Example 60, wherein the audio threshold includes at least one of a volume level value and a duration value.

Example 62 includes the subject matter of Example 60, wherein the audio threshold is user-configurable.

Example 63 includes the subject matter of any of Examples 50-62 and 65-66, wherein analyzing audio data received in the video conferencing session is performed in real time.

Example 64 includes the subject matter of any of Examples 50-62 and 65-66, wherein analyzing audio data received in the video conferencing session is performed at a user-configurable interval.

Example 65 includes the subject matter of any of Examples 50-64, wherein at least a portion of the method is carried out via an IR.94-based implementation.

Example 66 includes the subject matter of any of Examples 50-64, wherein at least a portion of the method is carried out via a WebRTC-based implementation.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

1. A non-transitory computer program product encoded with instructions that, when executed by one or more processors, causes a process to be carried out, the process comprising:
receiving audio data in a video conferencing session;
analyzing the audio data to determine an audio activity level of at least one participant of the video conferencing session; and
adjusting a video composition of a graphical user interface (GUI) based on the audio activity level of the at least one participant.

2. The non-transitory computer program product of claim 1, wherein analyzing the audio data to determine the audio activity level of the at least one participant comprises:
sampling the audio data received in the video conferencing session and computing therefrom an audio signature to identify which participant is associated with the audio data; and
comparing the audio data against an audio threshold.

3. The non-transitory computer program product of claim 1, wherein upon comparing the audio data against the audio threshold, if the audio data exceeds the audio threshold, then adjusting the video composition of the GUI comprises:
automatically transitioning presentation of a video stream representative of the participant from a thumbnail region of the GUI to a prominent region of the GUI;
automatically transitioning presentation of a video stream representative of the participant from a thumbnail region of the GUI to a prominent region of the GUI and automatically transitioning presentation of a video stream representative of another participant from the prominent region of the GUI to the thumbnail region of the GUI; or
maintaining presentation of a video stream representative of the participant within a prominent region of the GUI.

4. The non-transitory computer program product of claim 1, wherein upon comparing the audio data against the audio threshold, if the audio data does not exceed the audio threshold, then adjusting the video composition of the GUI comprises:
automatically transitioning presentation of a video stream representative of the participant from a prominent region of the GUI to a thumbnail region of the GUI; or
maintaining presentation of a video stream representative of the participant within a thumbnail region of the GUI.

5. The non-transitory computer program product of claim 1, wherein adjusting the video composition of the GUI comprises at least one of:
transitioning presentation of a video stream representative of at least one of a remote participant and an object/scene of interest between a prominent region of the GUI and a thumbnail region of the GUI;
adjusting a resolution of a video stream representative of at least one remote participant; and
adjusting a frame rate of a video stream representative of at least one remote participant.

6. The non-transitory computer program product of claim 1, wherein adjusting the video composition of the GUI is performed automatically based on the audio activity level of a local or remote participant causing the adjusting.

7. The non-transitory computer program product of claim 1, wherein adjusting the video composition of the GUI is further based on input received via a touch-sensitive display on which the GUI is presented.

8. The non-transitory computer program product of claim 1, wherein at least a portion of the process is carried out via at least one of an IR.94-based implementation and a WebRTC-based implementation.

9. A non-transitory computer program product encoded with instructions that, when executed by one or more processors, causes a process to be carried out, the process comprising:
receiving audio data in a video conferencing session, the audio data including at least one audio stream associated with an individual remote video conferencing participant; and
adjusting a volume level of the at least one audio stream associated with the individual remote video conferencing participant.

10. The non-transitory computer program product of claim 9, wherein at least a portion of the process is carried out via a WebRTC-based implementation.

11. The non-transitory computer program product of claim 9, wherein:
prior to adjusting the volume level of the at least one audio stream associated with the individual remote video conferencing participant, the process further comprises splitting the audio data into a plurality of audio streams, the plurality including the at least one audio stream associated with the individual remote video conferencing participant; and
after adjusting the volume level of the at least one audio stream associated with the individual remote video conferencing participant, the process further comprises re-synthesizing the plurality of audio streams into a single audio stream.

12. The non-transitory computer program product of claim 11, wherein at least a portion of the process is carried out via an IR.94-based implementation.

13. A non-transitory computer program product encoded with instructions that, when executed by one or more processors, causes a process to be carried out, the process comprising:
receiving audio data in a video conferencing session;
analyzing the audio data to determine therefrom an audio activity level of a local participant of the video conferencing session; and
adjusting at least one of a resolution and a frame rate of video data transmitted in the video conferencing session based on the audio activity level of the local participant.

14. The non-transitory computer program product of claim 13, wherein adjusting at least one of the resolution and the frame rate of the video data transmitted in the video conferencing session comprises:
adjusting at least one of a capture resolution and a capture frame rate of an image capture device configured to capture the video data before encoding thereof.

15. The non-transitory computer program product of claim 13, wherein adjusting at least one of the resolution and the frame rate of the video data transmitted in the video conferencing session comprises:
scaling at least one of the resolution and the frame rate of captured video data before encoding thereof.

16. The non-transitory computer program product of claim 13, wherein analyzing the audio data to determine therefrom the audio activity level of the local participant comprises:
sampling the audio data received in the video conferencing session and computing therefrom an audio signature to identify which participant is associated with the audio data; and
comparing the audio data against an audio threshold.

17. The non-transitory computer program product of claim 16, wherein upon comparing the audio data against the audio threshold, if the audio data exceeds the audio threshold, then adjusting at least one of the resolution and the frame rate of the video data comprises at least one of:
automatically increasing at least one of a capture resolution and a capture frame rate of an image capture device configured to capture the video data before encoding thereof; and
automatically upscaling at least one of the resolution and the frame rate of the video data before encoding thereof.

18. The non-transitory computer program product of claim 16, wherein upon comparing the audio data against the audio threshold, if the audio data does not exceed the audio threshold, then adjusting at least one of the resolution and the frame rate of the video data comprises at least one of:
automatically decreasing at least one of a capture resolution and a capture frame rate of an image capture device configured to capture the video data before encoding thereof; and
automatically downscaling at least one of the resolution and the frame rate of the video data before encoding thereof.

19. The non-transitory computer program product of claim 13, wherein at least a portion of the process is carried out via at least one of an IR.94-based implementation and a WebRTC-based implementation.

20. A non-transitory computer program product encoded with instructions that, when executed by one or more processors, causes a process to be carried out, the process comprising:
receiving video data in a video conferencing session; and
adjusting a video composition of a graphical user interface (GUI) based on input by a local participant.

21. The non-transitory computer program product of claim 20, wherein adjusting the video composition of the GUI comprises:
locating a prominent region and a thumbnail region within the GUI;
splitting the video data into a plurality of video streams including at least a first video stream for the prominent region and a second video stream for the thumbnail region; and
recomposing the plurality of video streams into a single video stream based on the input of the local participant.

22. The non-transitory computer program product of claim 20, wherein adjusting the video composition of the GUI comprises:
transitioning presentation of a video stream representative of a remote participant from a thumbnail region of the GUI to a prominent region of the GUI; or
maintaining presentation of a video stream representative of the remote participant within a prominent region of the GUI.

23. The non-transitory computer program product of claim 20, wherein adjusting the video composition of the GUI comprises:
transitioning presentation of a video stream representative of a remote participant from a prominent region of the GUI to a thumbnail region of the GUI; or
maintaining presentation of a video stream representative of the remote participant within a thumbnail region of the GUI.

24. The non-transitory computer program product of claim 20, wherein adjusting the video composition of the GUI comprises:
adjusting at least one of a resolution and a frame rate of a video stream representative of a remote participant presented locally via the GUI.

25. The non-transitory computer program product of claim 20, wherein at least a portion of the process is carried out via at least one of an IR.94-based implementation and a WebRTC-based implementation.
